(19) United States
(12) Patent Application Publication
(10) Pub. No.: US 2026/0011282 A1
(43) Pub. Date: Jan. 8, 2026

(54) ELECTRONIC DEVICE COMPRISING ILLUMINANCE SENSOR AND METHOD FOR OPERATING SAME

(71) Applicant: Samsung Electronics Co., Ltd., Suwon-si (KR)

(72) Inventors: Heewoong YOON, Suwon-si (KR); Jongah KIM, Suwon-si (KR); Kihyuk LEE, Suwon-si (KR); Donghan LEE, Suwon-si (KR); Gwangho CHOI, Suwon-si (KR)

(21) Appl. No.: 19/328,437

(22) Filed: Sep. 15, 2025

Related U.S. Application Data
(63) Continuation of application No. PCT/KR2024/004508, filed on Apr. 5, 2024.

(30) Foreign Application Priority Data
Apr. 13, 2023 (KR) 10-2023-0048971
May 19, 2023 (KR) 10-2023-0065134

(51) Int. Cl. G09G 3/20

(52) U.S. Cl. CPC G09G 3/2092; G09G 2320/0626; G09G 2360/144

(57) ABSTRACT

An electronic device is provided. The electronic device includes a display which displays a screen, visually exposed at the front, through at least a portion of a panel including a plurality of pixels, a display driver configured to control the on/off of the plurality of pixels of the display based on a designated scanning operation period or a designated duty ratio, a photodiode positioned behind or to one side of the display, an illuminance sensor including a capacitor electrically connected to the photodiode and a conversion element configured to acquire signals related to the voltage of the capacitor, memory, including one or more storage media, storing instructions, and at least one processor communicatively coupled to the display, the display driver, the illuminance sensor, and the memory, wherein the instructions, when executed by the at least one processor individually or collectively, cause the electronic device to transmit, to the illuminance sensor, signals related to a plurality of time intervals set based on the designated scanning operation period or the designated duty ratio, identify the signal related to the voltage of the capacitor cumulatively charged during the set plurality of time intervals by the photodiode, and obtain data related to illuminance based on the received signals related to the voltage of the capacitor.

### CROSS-REFERENCE TO RELATED APPLICATION(S)

This application is a continuation application, claiming priority under 35 U.S.C. § 365(c), of an International application No. PCT/KR2024/004508, filed on Apr. 5, 2024, which is based on and claims the benefit of a Korean patent application number 10-2023-0048971, filed on Apr. 13, 2023, in the Korean Intellectual Property Office, and of a Korean patent application number 10-2023-0065134, filed on May 19, 2023, in the Korean Intellectual Property Office, the disclosure of each of which is incorporated by reference herein in its entirety.

### BACKGROUND

### 1. Field

The disclosure relates to an electronic device including an illuminance sensor for measuring the intensity of ambient light and a method for operating the same.

### 2. Description of Related Art

Electronic devices, such as smartphones and tablets equipped with displays may measure the intensity of ambient light through an illuminance sensor and use the intensity of light measured through the illuminance sensor to adjust the luminance of the display. For example, when the surroundings are bright, the luminance of the display is relatively increased, and conversely, when the surroundings are dark, the luminance of the display is relatively lowered, thereby automatically displaying a screen with appropriate luminance for the surrounding environment.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including an illuminance sensor for measuring the intensity of ambient light and a method for operating the same.

Additional aspects will be set forth in part in the description which follows and, in part, will be apparent from the description, or may be learned by practice of the presented embodiments.

In accordance with an electronic device is provided. The electronic device includes a display configured to present a screen visually exposed to a front side through at least a partial area of a panel including a plurality of pixels, a display driver configured to control an/off operations of the plurality of pixels of the display based on a designated scanning operation period or a designated duty ratio, an illuminance sensor including a photodiode disposed at a rear or side of the display, a capacitor electrically connected to the photodiode, and a conversion element configured to obtain a signal related to a voltage of the capacitor, memory, including one or more storage media, storing instructions, and at least one processor communicatively coupled to the display, the display driver, the illuminance sensor, and the memory, wherein the instructions, when executed by the at least one processor individually or collectively, cause the electronic device to transmit, to the illuminance sensor, a signal related to a plurality of time intervals set based on the designated scanning operation period and/or the designated duty ratio, identify the signal related to the voltage of the capacitor received from the illuminance sensor, the capacitor being cumulatively charged by the photodiode during the set plurality of time intervals, and obtain data related to illuminance based on the identified signal related to the voltage of the capacitor.

In accordance with another aspect of the disclosure, a method for operating an electronic device is provided. The method includes transmitting, to an illuminance sensor, a signal related to a plurality of time intervals set based on a designated scanning operation period and/or a designated duty ratio of a display, the display including a plurality of pixels, identifying a signal related to a voltage of a capacitor received from the illuminance sensor, the capacitor being cumulatively charged by a photodiode during the plurality of time intervals, the capacitor electrically connected to the photodiode, and obtaining data related to illuminance based on the identified signal related to the voltage of the capacitor.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include transmitting, to an illuminance sensor, a signal related to a plurality of time intervals set based on a designated scanning operation period and/or a designated duty ratio of a display, the display including a plurality of pixels, identifying a signal related to a voltage of a capacitor received from the illuminance sensor, the capacitor being cumulatively charged by a photodiode during the designated plurality of time intervals, the capacitor being electrically connected to the photodiode, and obtaining data related to illuminance based on the identified signal related to the voltage of the capacitor.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an electronic device according to an embodiment of the disclosure;

FIG. 3 is an exploded perspective view illustrating an illuminance sensor according to an embodiment of the disclosure;

FIG. 4 illustrates operation signals of an illuminance sensor according to an embodiment of the disclosure;

FIG. 5 illustrates a configuration of a display according to an embodiment of the disclosure;

FIG. 6 illustrates operation signals of a display according to an embodiment of the disclosure;

FIGS. 7A and 7B illustrate configurations in which an illuminance sensor is disposed according to various embodiments of the disclosure;

FIG. 8 illustrates operation signals related to illuminance measurement of an illuminance sensor according to an embodiment of the disclosure;

FIG. 9A illustrates operation signals in a short mode of an illuminance sensor according to a comparative example according to an embodiment of the disclosure;

FIG. 9B illustrates operation signals in a short mode of an illuminance sensor in which noise occurs according to a comparative example according to an embodiment of the disclosure;

FIG. 9C illustrates operation signals in a short mode of an illuminance sensor when an AC light source is present according to a comparative example according to an embodiment of the disclosure;

FIG. 10 is a block diagram of an illuminance sensor according to an embodiment of the disclosure;

FIG. 11 is a graph illustrating responsiveness to wavelength bands of an illuminance sensor according to an embodiment of the disclosure;

FIG. 12 illustrates operation signals in a short mode of an illuminance sensor according to an embodiment of the disclosure;

FIG. 13 is a voltage graph of a capacitor charged in a plurality of time intervals according to an embodiment of the disclosure;

FIGS. 14A, 14B, and 14C illustrate block diagrams of an illuminance sensor in respective operation modes according to various embodiments of the disclosure;

FIG. 15A illustrates operation signals of an illuminance sensor when the same environment is maintained according to an embodiment of the disclosure;

FIG. 15B illustrates operation signals of an illuminance sensor when changing from a low illuminance environment to a high illuminance environment according to an embodiment of the disclosure;

FIG. 15C illustrates operation signals of an illuminance sensor when changing from a high illuminance environment to a low illuminance environment according to an embodiment of the disclosure;

FIG. 16 illustrates operation signals in a short mode of an illuminance sensor when an AC light source is present according to an embodiment of the disclosure;

FIGS. 17A and 17B are flowcharts related to an operation method of an electronic device according to various embodiments of the disclosure; and

FIGS. 18A and 18B are flowcharts related to an operation method of an illuminance sensor according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

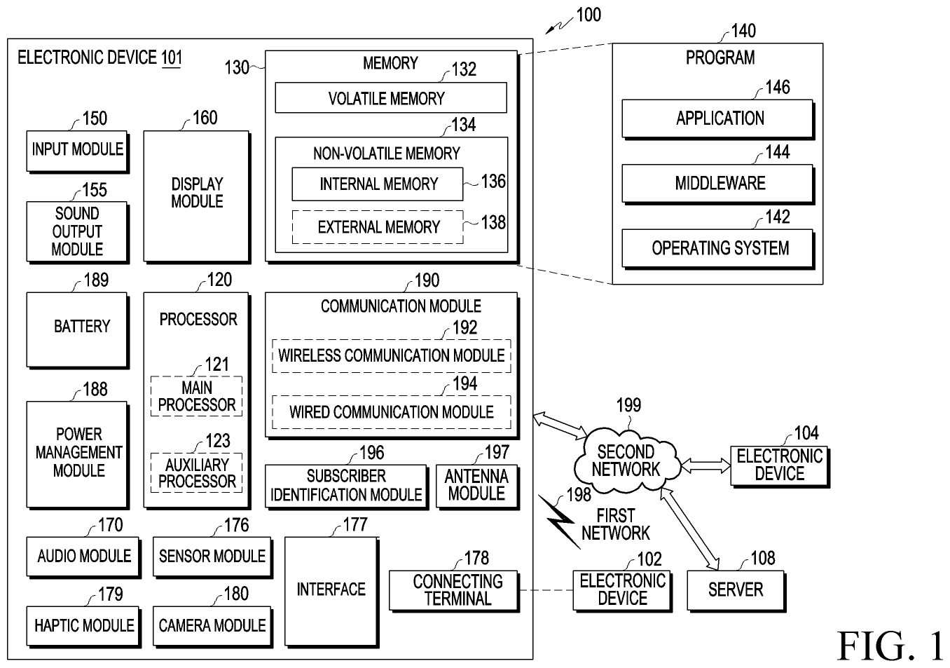

FIG. 1 is a block diagram illustrating an electronic device in a network environment according to an embodiment of the disclosure.

Referring to FIG. 1, an electronic device 101 in a network environment 100 may communicate with at least one of an external electronic device 102 via a first network 198 (e.g., a short-range wireless communication network), or an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment of the disclosure, at least one (e.g., the connecting terminal 178) of the components may be omitted from the electronic device 101, or one or more other components may be added in the electronic device 101. According to an embodiment of the disclosure, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor configured to detect a touch, or a pressure sensor configured to measure the intensity of a force generated by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to an embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment of the disclosure, the antenna module 197 may include one antenna including a radiator formed of a conductor or conductive pattern formed on a substrate (e.g., a printed circuit board (PCB)). According to an embodiment of the disclosure, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment of the disclosure, other parts (e.g., radio frequency integrated circuit (RFIC)) than the radiator may be further formed as part of the antenna module 197.

According to an embodiment of the disclosure, the antenna module 197 may form a mmWave antenna module. According to an embodiment of the disclosure, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

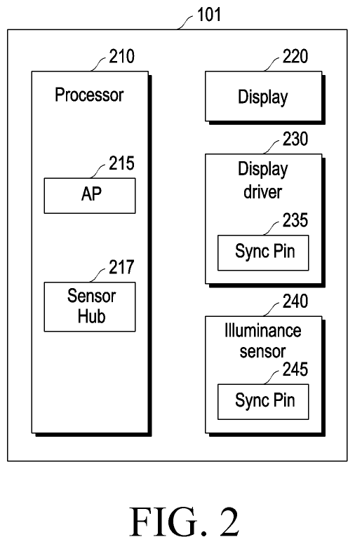

FIG. 2 is a block diagram illustrating an electronic device according to an embodiment of the disclosure.

Referring to FIG. 2, an electronic device 101 according to an embodiment may include a processor 210, a display 220, a display driver 230, and/or an illuminance sensor 240. Further, the electronic device 101 may further include individual components of the electronic device 101 included in FIG. 1, or may exclude some components.

The processor 210 according to an embodiment may execute software stored in memory (not illustrated, e.g., the memory 130 of FIG. 1) to control at least one other component (e.g., hardware or software component) of the electronic device 101 operatively connected to the processor 210. The processor 210 according to an embodiment may perform various data processing or calculations. The processor 210 may include processing circuitry.

The processor 210 according to an embodiment may be a single component or may be an a plurality of components divided or separated. The processor 210 according to an embodiment may be configured as a main processor (e.g., application processor) that performs high-performance processing and an auxiliary processor (e.g., supplementary processor, sensor hub) that performs low-power processing. In the disclosure, a description that a processor 210 may perform certain operations (or functions, tasks, or actions) may be interpreted as substantially the same as indicating that instructions (or commands or computer programs) for causing the electronic device (or the processor 210) to perform the operations are stored in memory (e.g., non-volatile memory or storage). In addition, a description that a processor may perform certain operations may be interpreted as substantially the same as indicating that at least one processor, unspecified in number, may individually or collectively perform the operations.

The processor according to an embodiment may include an application processor (AP) 215 and/or a sensor hub 217. Here, the AP 215 and the sensor hub 217 are illustrated as separate components, but may be integrated into one hardware component or formed integrally.

The AP 215 according to an embodiment may control the display screen of the display 220 and properties of the display 220. For example, the properties of the display 220 may include color or brightness. In an embodiment of the disclosure, the AP 215 may obtain data related to illuminance through the illuminance sensor 240 and the sensor hub 217, and determine ambient illuminance using the obtained data related to illuminance. In an embodiment of the disclosure, the AP 215 may determine the luminance of the display 220 based on the determined ambient illuminance (e.g., brightness [lux]).

The processor 210 (e.g., AP 215) according to an embodiment may increase the luminance of the display 220 to ensure visibility when the surroundings are bright due to sunlight, such as outdoors. The processor 210 (e.g., AP 215) according to an embodiment may decrease the luminance of the display 220 to prevent glare to the user's eyes when the surroundings are dark. In an embodiment of the disclosure, the processor 210 (e.g., AP 215) may remove at least a portion of blue light from the output light for the user's eye protection or sleep health.

The sensor hub 217 according to an embodiment may manage the overall operation of the sensor module (e.g., the sensor module 176 of FIG. 1) included in the electronic device 101. For example, since high-performance processing through the sensor module 176 is not required and constant measurement is possible with low power, the sensor hub 217 may be used as an auxiliary processor.

The display 220 according to an embodiment may be various types of screen display devices, such as organic light emitting diode (LED) (OLED), quantum-dot LED (QLED), liquid crystal display (LCD) according to the display method or structure. In an embodiment of the disclosure, the display 220 may include lighting that separately generates backlight from the rear surface. In an embodiment of the disclosure, the display 220 may include a plurality of pixels (not illustrated), and each pixel (not illustrated) may directly generate light.

In an embodiment of the disclosure, the display 220 may generate light to display a screen, and the light generated by the display 220 may affect the measured value of illuminance measured by the illuminance sensor 240.

In an embodiment of the disclosure, the display 220 may have properties, such as color or luminance displayed on the screen. In an embodiment of the disclosure, the properties of the display 220 may be manually changed by user input, or may be automatically changed by the processor (e.g., AP 215). In an embodiment of the disclosure, the display 220 may increase luminance by increasing the duty ratio. In an embodiment of the disclosure, the display 220 may decrease luminance by decreasing the duty ratio.

A display driver 230 (display driver interface (DDI)) according to an embodiment may be a semiconductor device that controls the display 220. In an embodiment of the disclosure, the display driver 230 may play a role of displaying a screen (e.g., image frame) generated from the AP 215 on the display 220.

In an embodiment of the disclosure, the display driver 230 may be designed to control driving signals and/or data to display images or videos on the display 220. In an embodiment of the disclosure, the display driver 230 may be connected to the display 220 through a flexible printed circuit board (FPCB) or film, and may be configured independently from the display 220.

In an embodiment of the disclosure, the display driver 230 may be a component integrally included in the display 220.

In an embodiment of the disclosure, the display 220 may include a plurality of pixels disposed along the longitudinal and transverse axes, and the display driver 230 may update the screen for the plurality of pixels included in the display 220 line by line.

In an embodiment of the disclosure, the display 220 may implement moving images by updating one or more image frames, and the plurality of pixels included in the display 220 repeat the on/off operation, and each pixel is turned on corresponding to updated pixel information, so that the screen displayed on the display 220 may be changed.

In an embodiment of the disclosure, the display driver 230 may include a sync pin 235 that transmits a synchronization signal to the illuminance sensor 240 or receives from the illuminance sensor 240 for timing synchronization with the illuminance sensor 240.

The illuminance sensor 240 according to an embodiment may be a sensor that measures the intensity of received ambient light. In an embodiment of the disclosure, the illuminance sensor 240 may include a photodiode (not illustrated) that receives external light and outputs voltage, and a conversion element (not illustrated) that outputs a signal related to a voltage value measured from the voltage output by the photodiode (not illustrated). In an embodiment of the disclosure, the conversion element (not illustrated) may include an analog-digital converter (ADC) element (not illustrated) that outputs the voltage of the photodiode (not illustrated) input in analog form in digital form.

In an embodiment of the disclosure, the photodiode (not illustrated) may receive light of a designated wavelength band and output it as a voltage. In an embodiment of the disclosure, the illuminance sensor 240 may further include a capacitor (not illustrated) that accumulates and stores the voltage output by the photodiode (not illustrated).

In an embodiment of the disclosure, the illuminance sensor 240 may include a sync pin 245 that receives a synchronization signal from the sync pin 235 included in the display driver 230, or transmits a synchronization signal to the sync pin 235 included in the display driver 230. In an embodiment of the disclosure, the illuminance sensor 240 may operate according to timing synchronized with the display driver 230 based on a synchronization signal received or transmitted through the sync pin 245.

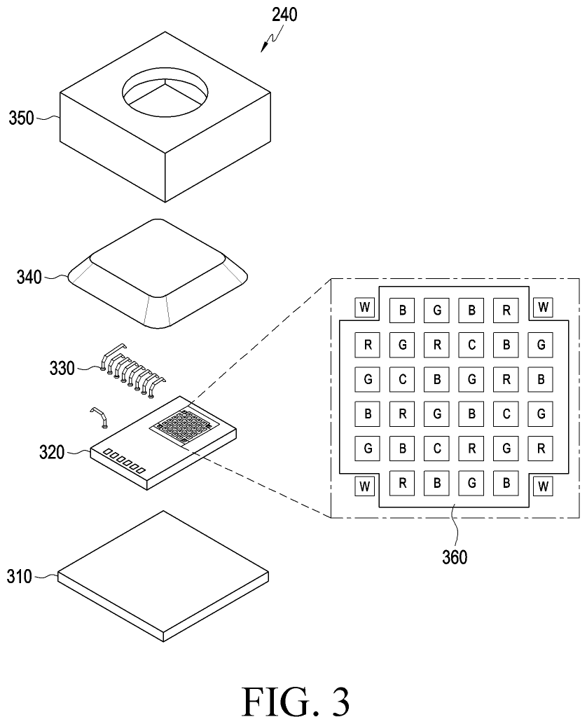

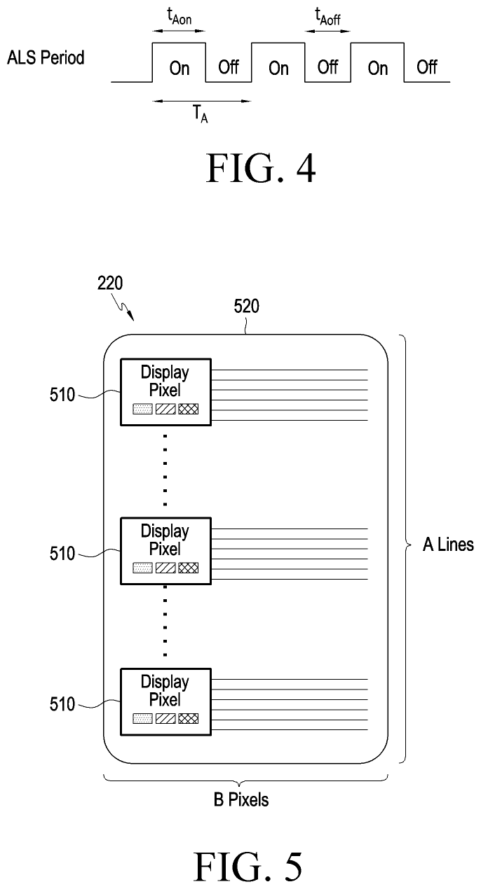

FIG. 3 is an exploded perspective view illustrating an illuminance sensor 240 according to an embodiment of the disclosure. FIG. 4 illustrates operation signals of an illuminance sensor 240 according to an embodiment of the disclosure.

Referring to FIGS. 3 and 4, the illuminance sensor 240 according to an embodiment may include a substrate 310, a die 320 fixed to the substrate 310 and where a photodiode 360 is mounted, a wire 330 bonded to the die 320, a compound mold 340 formed by being molded on the die 320 with a resin material, and/or a cap 350 fixedly coupled to the substrate 310 at the bottom to cover other components or members.

In an embodiment of the disclosure, the photodiodes 360 included in the illuminance sensor 240 may be formed in an array structure disposed along the x-axis and y-axis. In an embodiment of the disclosure, the array of photodiodes 360 includes at least one cell disposed along the x-axis and y-axis, and the at least one cell may each respond to light corresponding to a designated wavelength band to output voltage. For example, at least one cell included in the photodiode 360 may output voltage in response to light corresponding to a red band, a green band, a blue band, and/or a clear band, respectively. For example, at least one cell included in the photodiode 360 may include a cell (not illustrated) that responds to light corresponding to an infrared band (e.g., 700 [nm] to 1000 [nm]) or a cell (W) that responds to light corresponding to a wide band (e.g., 400 [nm] to 1000 [nm]).

Referring to FIG. 4, the illuminance sensor 240 (ambient light sensor (ALS)) according to an embodiment may operate by repeatedly switching on/off operations according to a designated period T_{A}. In an embodiment of the disclosure, the illuminance sensor 240 may operate only in an on state t_{AON} and may stop operation in an off state based on the designated period T_{A}. For example, the designated period T_{A} may be pre-designated in the illuminance sensor, determined by the user, or changed according to conditions.

In an embodiment of the disclosure, the illuminance sensor 240 may output voltage corresponding to the intensity of light in a designated band through at least one cell included in the photodiode 360 in the on state t_{AON}. In an embodiment of the disclosure, the conversion element (not illustrated) of the illuminance sensor 240 may measure the voltage output by the photodiode 360 and output a signal related to the voltage value.

In an embodiment of the disclosure, the sensor sensitivity of the illuminance sensor 240 may be determined by the integration time (IT) and/or the size of the photodiode 360. For example, the larger the integration time of the illuminance sensor 240, the larger the sensor sensitivity may be. For example, the larger the size of the photodiode 360, the larger the sensor sensitivity may be.

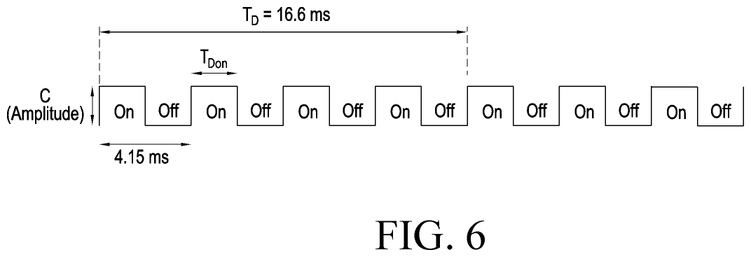

FIG. 5 illustrates a configuration of a display 220 according to an embodiment of the disclosure. FIG. 6 illustrates operation signals of a display 220 according to an embodiment of the disclosure.

Referring to FIGS. 5 and 6, the display 220 according to an embodiment includes a panel 520 (or display panel) that displays a screen visually exposed at the front, and the panel 520 of the display 220 may include a plurality of pixels 510.

In an embodiment of the disclosure, the display 220 may include A scanning lines, and each scanning line may be in an array form including B pixels. For example, a full HD display may include 1920*1080 pixels, and a QHD display may include 2560*1440 pixels.

In an embodiment of the disclosure, the display 220 may operate to simultaneously or sequentially turn on/off B pixels 510 constituting one scanning line, based on a designated scanning operation period T_{D}. In an embodiment of the disclosure, by the scanning operation of the display 220, the plurality of pixels 510 included in the display 220 may update a screen corresponding to an image frame. For example, the plurality of pixels 510 included in the display 220 may operate to turn on/off at about 30 to 120 [Hz] according to a designated scanning operation, and as an example, it is described that the scanning line operates at 60 [Hz] so that the designated scanning operation period T_{D} is 16.6 [ms].

In an embodiment of the disclosure, the plurality of pixels 510 included in the display 220 may be set to perform on/off operations at least once within the designated scanning operation period T_{D}. For example, the plurality of pixels 510 perform on/off operations 4 times within one designated scanning operation period T_{D}. One on/off operation period may be 4.15 [ms].

In an embodiment of the disclosure, the electronic device 101 may adjust the luminance of the screen displayed on the display 220 by controlling the time T_{Don} when each pixel 510 operates on, or by controlling the base luminance C when each pixel 510 operates on.

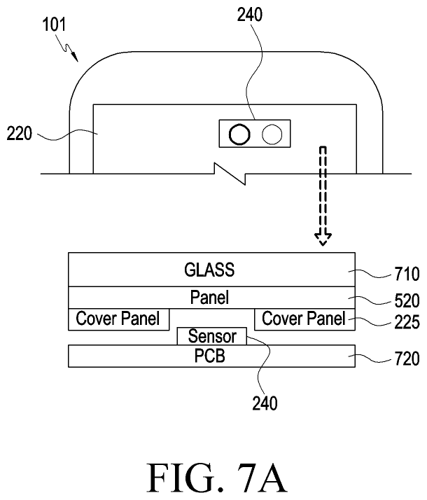

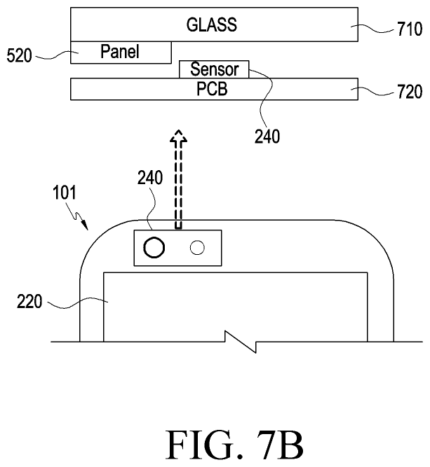

FIGS. 7A and 7B illustrate configurations in which an illuminance sensor is disposed according to various embodiments of the disclosure.

Referring to FIGS. 7A and 7B, the illuminance sensor 240 according to an embodiment may be disposed to avoid interference from light output by the display 220 (e.g., the panel 520 displaying the screen of the display 220) in the electronic device 101.

Referring to FIG. 7A, the illuminance sensor 240 may be an under-panel illuminance sensor mounted on the rear surface of the panel 520 of the display 220 that generates light to display a screen to the front. For example, the panel 520 of the display 220 may be provided with a glass layer 710 at the front and an illuminance sensor 240 mounted on a printed circuit board (PCB) 720 at the rear, and a cover panel 225 may be disposed at a side of the illuminance sensor 240 to surround the illuminance sensor 240.

Referring to FIG. 7B, the illuminance sensor 240 may be disposed at the side of the panel 520 of the display 220. For example, the panel 520 of the display 220 may be provided with a glass layer 710 through which light emitted from the panel 520 is transmitted at the front, and an illuminance sensor 240 mounted on a PCB 720 at the side of the panel 520.

In an embodiment of the disclosure, the illuminance sensor 240 may be disposed in a direction opposite to the direction in which the panel 520 of the display 220 emits light or at the side, thereby avoiding direct optical noise from the panel 520 of the display 220.

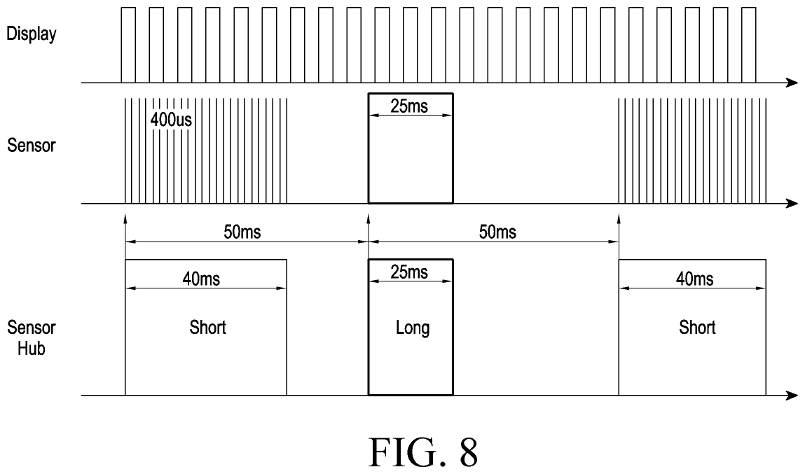

FIG. 8 illustrates operation signals related to illuminance measurement of an illuminance sensor according to an embodiment of the disclosure.

Referring to FIG. 8, an electronic device (e.g., the electronic device 101 of FIG. 2) according to an embodiment may measure ambient illuminance in each of a first measurement mode (e.g., short mode) and/or a second measurement mode (e.g., long mode) through an illuminance sensor (e.g., illuminance sensor 240 of FIG. 2). For example, the first measurement mode (e.g., short mode) and the second measurement mode (e.g., long mode) may be used one by one, but the electronic device 101 according to an embodiment may measure ambient illuminance more accurately by periodically cross-operating the illuminance sensor 240. For example, there is no priority between the first measurement mode (e.g., short mode) and the second measurement mode (e.g., long mode), and the electronic device 101 according to an embodiment may operate the illuminance sensor 240 in the first measurement mode (e.g., short mode) first, or may operate in the second measurement mode (e.g., long mode) first, according to the case.

In an embodiment of the disclosure, the electronic device 101 may measure ambient illuminance in short mode through the illuminance sensor 240. In an embodiment of the disclosure, in short mode, the integration time IT is set to be relatively short (e.g., 400 [μs]), and the electronic device 101 may measure ambient illuminance based on the voltage value measured by the illuminance sensor 240 in the off operation interval of the display 220 (e.g., the display 220 of FIG. 2).

In an embodiment of the disclosure, the electronic device 101 (e.g., sensor hub 217) may operate to measure ambient illuminance according to the designated illuminance measurement period (e.g., 50 [ms]), and may measure ambient illuminance through the illuminance sensor 240 for a designated time (e.g., 40 [ms]) within the designated illuminance measurement period. In an embodiment of the disclosure, the illuminance sensor 240 may measure ambient illuminance for each integration time by repeating a relatively short set integration time (IT, e.g., 400 [μs]) multiple times within the designated time during which the sensor hub 217 measures illuminance in short mode.

In an embodiment of the disclosure, the electronic device 101 may measure ambient illuminance in long mode through the illuminance sensor 240. In an embodiment of the disclosure, in long mode, the integration time IT is set to be relatively long (e.g., 25 [ms]), and the electronic device 101 may measure ambient illuminance based on the voltage value measured by the illuminance sensor 240 in the on operation interval and off operation interval of the display 220. For example, the electronic device 101 (e.g., sensor hub 217) may compensate for optical noise due to the on operation of the display 220 using a color of pixel ratio (COPR) value.

In an embodiment of the disclosure, the electronic device 101 (e.g., sensor hub 217) may measure ambient illuminance according to the designated illuminance measurement period (e.g., 50 [ms]), and may measure ambient illuminance in long mode for a designated time (e.g., 25 [ms]) within the designated illuminance measurement period. In an embodiment of the disclosure, the illuminance sensor 240 may measure ambient illuminance during one relatively long set integration time (IT, e.g., 25 [ms]) within the designated time during which the sensor hub 217 measures illuminance in long mode. For example, the illuminance sensor 240 may repeat the integration time multiple times in the designated illuminance measurement period or designated time even in long mode.

In an embodiment of the disclosure, the short mode has an integration time of 400 [μs], and may have about 1/60 lower sensitivity compared to long mode with an integration time of 25 [ms]. Accordingly, the illuminance sensor 240, which may not perceive light in a low illuminance environment based on low sensitivity, may cause an error of measuring 0 [lux] even though there is light in the surroundings. To enhance the sensitivity of the illuminance sensor 240, the size of the integration time may be increased, or the size of the photodiode (e.g., the photodiode 360 of FIG. 3) may be increased. However, since the off operation interval of the display 220 is determined, there is a limit to the size of the integration time. For example, when the off operation interval of the display 220 is 1 [ms], the integration time of the illuminance sensor 240 may need to be set to 800 [μs] or less. Further, when the size of the photodiode 360 increases, both the cost and size may increase.

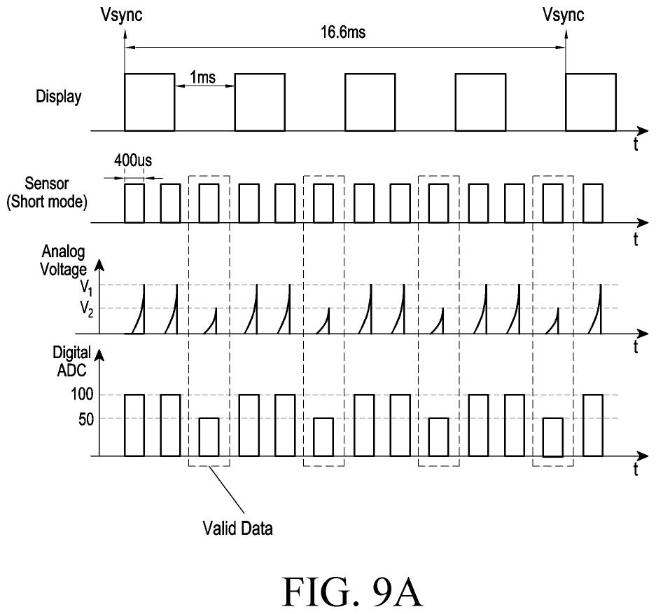

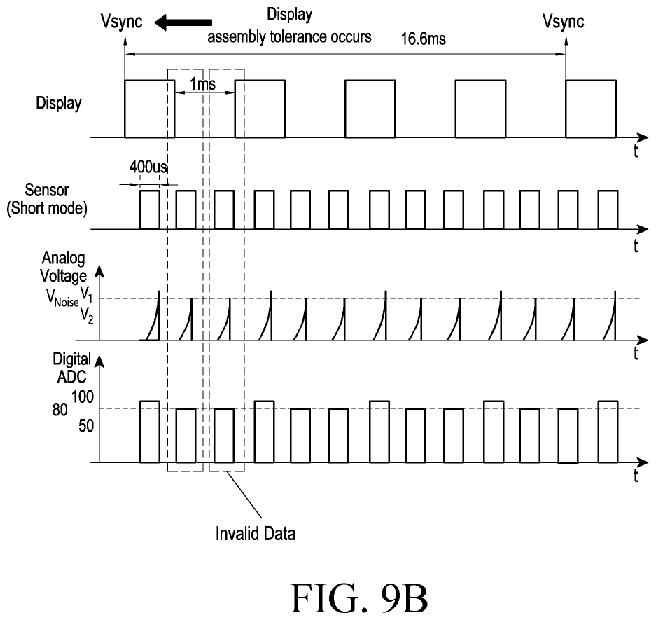

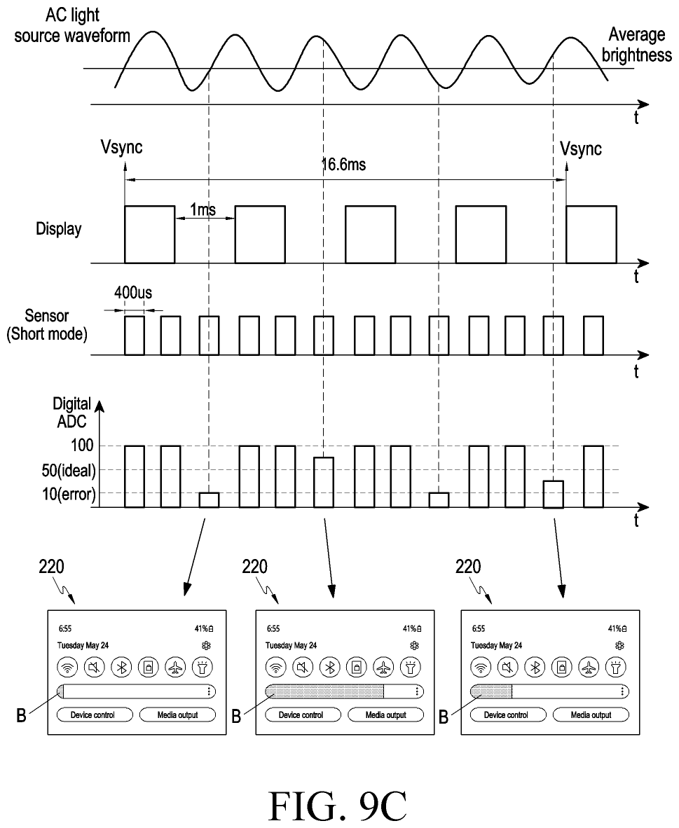

FIG. 9A illustrates operation signals in a short mode of an illuminance sensor 240 according to an embodiment of the disclosure. FIG. 9B illustrates operation signals in a short mode of an illuminance sensor 240 in which noise occurs according to an embodiment of the disclosure. FIG. 9C illustrates operation signals in a short mode of an illuminance sensor 240 when an AC light source is present according to an embodiment of the disclosure.

Referring to FIG. 9A, an electronic device (e.g., the electronic device 101 of FIG. 2) according to an embodiment may measure ambient illuminance in short mode through an illuminance sensor (e.g., illuminance sensor 240 of FIG. 2). In an embodiment of the disclosure, a display (e.g., the display 220 of FIG. 2) may operate on/off based on a designated scanning period or a vertical synchronization signal Vsync of a display drive (e.g., the display driver 230 of FIG. 2). As an example, the display 220 may operate on/off based on a scanning rate of 60 [Hz] or a designated scanning period of 16.6 [ms], and each pixel (e.g., the plurality of pixels 510 of FIG. 5) may repeat the on/off operations four times in one scanning period. For example, the off operation interval between on operation intervals of the display 220 may be 1 [ms].

The illuminance sensor 240 according to an embodiment may repeatedly turn on/off the photodiode 360 based on a designated period, and the photodiode 360 may receive light during the on operation and output it as voltage. As an example, the integration time of the on operation of the photodiode 360 may be set to 400 [μs], which is shorter than the off operation (1 [ms]) of the display 220.

The illuminance sensor 240 according to an embodiment may repeatedly turn on/off the photodiode 360 independently from the on/off operation of the display 220. For example, when the illuminance sensor 240 operates the photodiode 360 in the on operation interval of the display 220, it receives both ambient light and optical interference from the display 220, so it may output the voltage of V1. For example, when the illuminance sensor 240 operates the photodiode 360 in the off operation interval of the display 220, it receives only ambient light, so it may output the voltage of V2, which is smaller than V1. In an embodiment of the disclosure, the conversion element (not illustrated) of the illuminance sensor 240 may output a signal related to a voltage value corresponding to the voltage V1 or V2 output by the photodiode 360.

In an embodiment of the disclosure, the photodiode 360 may output voltage due to ambient light in the on operation interval, and the output voltage may drop to 0 when it may not receive light in the off operation interval.

The electronic device 101 according to an embodiment may measure ambient illuminance based on the voltage value measured through the conversion element (not illustrated) while the illuminance sensor 240 repeatedly turns on/off the photodiode 360 independently from the on/off operation of the display 220. In an embodiment of the disclosure, the electronic device 101 may measure the voltage value (e.g., 50) measured in the off operation interval of the display 220, which is smaller than the voltage value (e.g., 100) measured in the on operation interval of the display 220, as ambient illuminance.

Referring to FIG. 9B, when assembly tolerance occurs in the display 220 included in the electronic device 101 according to an embodiment of the disclosure, causing a shift in the on/off operation intervals of the display 220, the on/off operation timing of the illuminance sensor 240 may be misaligned with the off operation interval of the display 220. For example, the on operation interval of the illuminance sensor 240 may not be completely included in the off operation interval of the display 220, and a portion may overlap the on operation interval of the display 220.

For example, when the on operation interval of the illuminance sensor 240 is completely included in the off operation interval of the display 220, the photodiode 360 outputs the voltage of V2, and accordingly, the conversion element (not illustrated) may output 50 as a signal related to the output voltage. In contrast, when the on operation interval of the illuminance sensor 240 partially overlaps the on operation interval of the display 220, the photodiode 360 outputs a voltage of Vₙₒᵢₛₑ due to optical noise from the display 220, and accordingly, the conversion element (not illustrated) may output 80 as a signal related to the output voltage. In other words, an error may occur in the illuminance measured by the illuminance sensor 240.

The electronic device 101 according to an embodiment may store data of the photodiode 360 corresponding to a plurality (e.g., 40-80) of consecutive integration times and identify the lowest value among the stored data as the ambient illuminance value to discover the measured value of the illuminance sensor 240 in the off operation interval of the display 220. Accordingly, a load for the operation of storing and processing a plurality (e.g., 40-80) of consecutive data occurs in the processor (e.g., the processor 210 of FIG. 2) of the electronic device 101, and errors in operation processing, such as data omission may occur due to errors in operation timing.

Further, the electronic device 101 requires a first in first out (FIFO) block (not illustrated) for storing a plurality (e.g., 40-80) of consecutive data, and accordingly, the size of the illuminance sensor 240 should be increased, the price increases, and current consumption may increase accordingly.

Referring to FIG. 9C, the electronic device 101 according to an embodiment may have difficulty accurately measuring the measured value of the illuminance sensor 240 when an alternating current (AC) light source is present. For example, when an AC light source that changes illuminance according to a designated frequency is present, the ambient illuminance of the electronic device 101 may change based on the designated frequency, and accordingly, the illuminance value measured by the illuminance sensor 240 may fluctuate.

Referring to FIG. 9C, the signal related to the output voltage output by the conversion element (not illustrated) received by each photodiode 360 in the off operation interval of the display 220 may be a value (e.g., 10) smaller than the normal value (e.g., 50), or may fluctuate as the illuminance of the AC light source changes. Accordingly, when the electronic device 101 adjusts the luminance of the display 220 based on the illuminance value measured through the illuminance sensor 240, it may repeatedly lower and then raise the luminance of the display 220 based on the fluctuation of the measured illuminance value, and the luminance value displayed on the sliding bar B related to the luminance of the display 220 displayed on the screen of the display 220 may fluctuate.

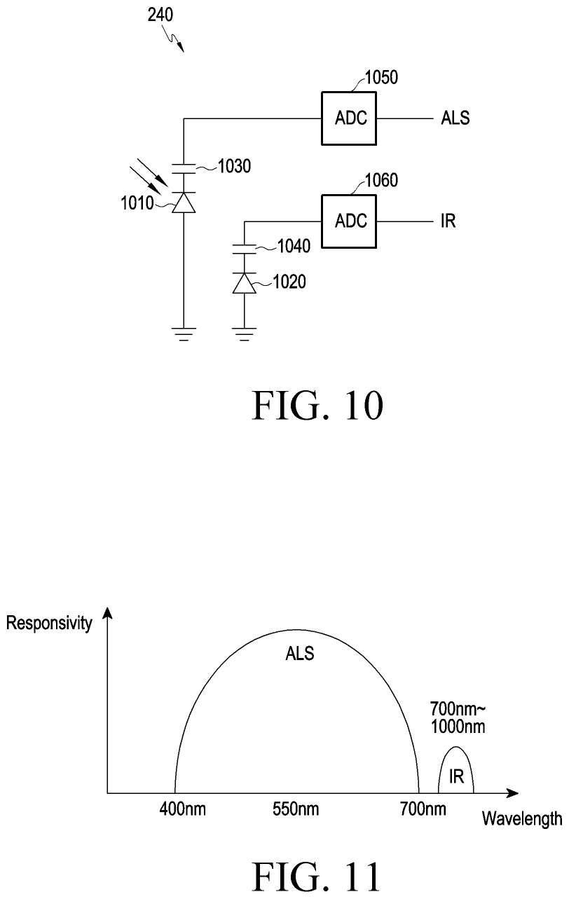

FIG. 10 is a block diagram of an illuminance sensor 240 according to an embodiment of the disclosure. FIG. 11 is a graph illustrating responsiveness to wavelength bands of an illuminance sensor 240 according to an embodiment of the disclosure. In the graph of FIG. 11, the x-axis is the wavelength band, and the y-axis is the responsiveness of the illuminance sensor 240 in each wavelength band.

Referring to FIGS. 10 and 11, the illuminance sensor 240 according to an embodiment may measure the intensity of light corresponding to a designated wavelength band. In an embodiment of the disclosure, the photodiodes 1010, 1020 included in the illuminance sensor 240 may receive light corresponding to a designated wavelength band and output voltage in a magnitude based on the intensity of the received light.

In an embodiment of the disclosure, the illuminance sensor 240 may include photodiodes 1010, 1020, and the photodiodes 1010, 1020 may include a first photodiode 1010 and a second photodiode 1020. In an embodiment of the disclosure, the first photodiode 1010 may receive light in the ambient light sensor (ALS) band, which is a visible light wavelength band (e.g., 400 [nm] to 700 [nm]). In an embodiment of the disclosure, the second photodiode 1020 may receive light in the infrared ray (IR) band, which is an IR wavelength band (e.g., 700 to 1000 [nm]).

In an embodiment of the disclosure, the first photodiode 1010 and the second photodiode 1020 are electrically connected to GND, and may generate a voltage difference with GND based on receiving light of a designated wavelength band, respectively. In an embodiment of the disclosure, when the reception of light in the first photodiode 1010 and the second photodiode 1020 is stopped, the voltage difference generated in the first photodiode 1010 and the second photodiode 1020 may be gradually discharged to GND.

In an embodiment of the disclosure, the illuminance sensor 240 may include capacitors 1030, 1040 electrically connected to the photodiodes 1010, 1020 so that the voltage difference generated in the photodiodes 1010, 1020 is not discharged in a very short time. Accordingly, based on the photodiodes 1010, 1020 receiving light for a plurality of time intervals, voltage may be cumulatively charged in the capacitors 1030, 1040.

In an embodiment of the disclosure, the capacitors 1030, 1040 may include a first capacitor 1030 and a second capacitor 1040. In an embodiment of the disclosure, the first capacitor 1030 may be electrically connected to the first photodiode 1010. In an embodiment of the disclosure, the second capacitor 1040 may be electrically connected to the second photodiode 1020. In an embodiment of the disclosure, the first capacitor 1030 may be disposed between the first photodiode 1010 and a first conversion element 1050 described below. In an embodiment of the disclosure, the second capacitor 1040 may be disposed between the second photodiode 1020 and a second conversion element 1060 described below.

In an embodiment of the disclosure, the first capacitor 1030 may be charged by voltage output based on the first photodiode 1010 receiving light in the visible light wavelength band. In an embodiment of the disclosure, the second capacitor 1040 may be charged by voltage output based on the second photodiode 1020 receiving light in the infrared wavelength band. In an embodiment of the disclosure, when the reception of light in the first photodiode 1010 and the second photodiode 1020 is stopped, the first capacitor 1030 and the second capacitor 1040 may be gradually discharged.

In an embodiment of the disclosure, the illuminance sensor 240 may include a first conversion element 1050 and a second conversion element 1060. In an embodiment of the disclosure, the first conversion element 1050 is connected to the first capacitor 1030 and may output a signal related to the voltage charged in the first capacitor 1030 based on the first photodiode 1010 receiving light in the visible light wavelength band.

In an embodiment of the disclosure, the second conversion element 1060 is connected to the second capacitor 1040 and may output a signal related to the voltage charged in the second capacitor 1040 based on the second photodiode 1020 receiving light in the infrared wavelength band.

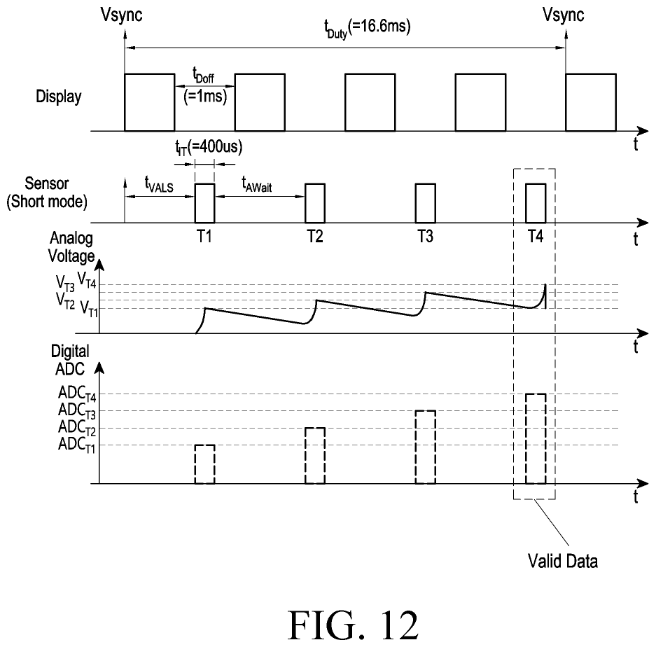

FIG. 12 illustrates operation signals in a short mode of an illuminance sensor 240 according to an embodiment of the disclosure.

Referring to FIG. 12, the illuminance sensor 240 according to an embodiment may measure ambient illuminance during a plurality of time intervals T1, T2, T3, T4. In an embodiment of the disclosure, the photodiodes (e.g., the photodiodes 1010, 1020 of FIG. 10) may receive light of a designated wavelength band during a plurality of time intervals T1, T2, T3, T4, respectively, and the capacitors (e.g., the capacitors 1030, 1040 of FIG. 10) may be cumulatively charged by the photodiodes 1010, 1020 during the plurality of time intervals T1, T2, T3, T4. In an embodiment of the disclosure, the plurality of time intervals T1, T2, T3, T4 may include a plurality of time intervals that are temporally separated from each other, and the capacitors 1030, 1040 may be at least partially discharged between the separated time intervals.

An electronic device (e.g., the electronic device 101 of FIG. 2, the processor 210 of FIG. 2) according to an embodiment may set the plurality of time intervals T1, T2, T3, T4 based on a designated scanning operation period t_{Duty} or a designated duty ratio. In an embodiment of the disclosure, the electronic device 101 may set a designated duty ratio of the display (e.g., the display 220 of FIG. 2) based on a designated scanning operation period t_{Duty} between vertical synchronization signals Vsync of a display driver (e.g., the display driver 230 of FIG. 2). In an embodiment of the disclosure, the electronic device 101 may set the integration time t_{π} of the plurality of time intervals T1, T2, T3, T4, the period t_{AWait} between the plurality of time intervals T1, T2, T3, T4, and/or the time t_{VALS} between the vertical synchronization signal Vsync and the first time interval T1 based on the designated scanning operation period tDuty and the designated duty ratio.

In an embodiment of the disclosure, the electronic device 101 may set the plurality of time intervals T1, T2, T3, T4 for each designated scanning operation period t_{Duty}. In an embodiment of the disclosure, the electronic device 101 may set the number of the plurality of time intervals T1, T2, T3, T4 to correspond to the number of repetitions of on/off operations of the display 220 (e.g., the plurality of pixels 510 of FIG. 5) included in each designated scanning operation period t_{Duty}.

In an embodiment of the disclosure, the electronic device 101 may set the plurality of time intervals T1, T2, T3, T4 to a number of intervals equal to or less than the number of on/off repetitions of the display 220 included in each designated scanning operation period t_{Duty}. For example, when the number of the on/off operations of the display 220 is four in the designated scanning operation period t_{Duty}, the plurality of time intervals T1, T2, T3, T4 included in the designated scanning operation period t_{Duty} may be set to 4.

In an embodiment of the disclosure, the electronic device 101 may set the plurality of time intervals T1, T2, T3, T4 within the off operation period t_{Doff} of the display 220 based on the designated scanning operation period t_{Duty} and the designated duty ratio of the display 220.

In an embodiment of the disclosure, the electronic device 101 may set the integration time t_{π} of the plurality of time intervals T1, T2, T3, T4 within the off operation period t_{Doff} of the display 220. For example, the electronic device 101 may set the integration time t_{π} of each of the plurality of time intervals T1, T2, T3, T4 to 400 [μs], which is shorter than 1 [ms], when the off operation period t_{Doff} of the display 220 is 1 [ms], based on the designated scanning operation period t_{Duty} and the designated duty ratio.

In an embodiment of the disclosure, the electronic device 101 may set the plurality of time intervals T1, T2, T3, T4 within the off operation period t_{Doff} of the display 220. In an embodiment of the disclosure, the electronic device 101 may set the first time interval T1 among the plurality of time intervals T1, T2, T3, T4 based on the vertical synchronization signal Vsync of the display driver 230. In an embodiment of the disclosure, the electronic device 101 may set the first time interval T1 after t_{VALS} from the vertical synchronization signal Vsync of the display driver 230. In an embodiment of the disclosure, the electronic device 101 may set the period between the plurality of time intervals T1, T2, T3, T4 to t_{AWait}.

In an embodiment of the disclosure, the display driver 230 may transmit a sync signal related to the timing for controlling on/off of the plurality of pixels 510 of the display 220 to the illuminance sensor 240. In an embodiment of the disclosure, the electronic device 101 may set the plurality of time intervals T1, T2, T3, T4 within the off operation period t_{Doff} of the display 220 based on the sync signal received from the display driver 230. In an embodiment of the disclosure, the illuminance sensor 240 may receive light of a designated wavelength band through the photodiodes 1010, 1020 during the plurality of time intervals T1, T2, T3, T4 based on the sync signal received from the display driver 230.

The electronic device 101 according to an embodiment may transmit a signal related to the plurality of time intervals T1, T2, T3, T4 set based on the designated scanning operation period t_{Duty} or the designated duty ratio to the illuminance sensor 240. The illuminance sensor 240 according to an embodiment may receive light through the photodiodes 1010, 1020 during the plurality of time intervals T1, T2, T3, T4 based on the received signal related to the plurality of time intervals T1, T2, T3, T4.

The illuminance sensor 240 according to an embodiment may cumulatively charge the capacitors 1030, 1040 based on receiving light through the photodiodes 1010, 1020 during the plurality of time intervals T1, T2, T3, T4. The capacitors 1030, 1040 according to an embodiment may be cumulatively charged during the plurality of time intervals T1, T2, T3, T4 and may be at least partially discharged between the plurality of time intervals T1, T2, T3, T4. For example, the voltage charged in the capacitors 1030, 1040 during the plurality of time intervals T1, T2, T3, T4 may be V_{T1}, V_{T2}, V_{T3}, and V_{T4}, respectively.

The illuminance sensor 240 according to an embodiment may transmit a signal related to the voltage of the capacitors 1030, 1040 to the electronic device 101.

The illuminance sensor 240 according to an embodiment may transmit signals ADC_{T1}, ADC_{T2}, ADC_{T3}, and ADC_{T4} related to a plurality of voltages corresponding to the plurality of time intervals T1, T2, T3, T4 of the capacitors 1030, 1040, respectively, to the electronic device 101.

The illuminance sensor 240 according to an embodiment may transmit a signal ADC_{T4} related to the finally charged voltage in the plurality of time intervals T1, T2, T3, T4 included in the designated scanning operation period t_{Duty} to the processor 210.

In an embodiment of the disclosure, the electronic device 101 may obtain data related to illuminance based on the signal related to the voltage of the capacitors 1030, 1040 received from the illuminance sensor 240. In an embodiment of the disclosure, the electronic device 101 may obtain data related to illuminance based on the signal ADC_{T4} related to the finally charged voltage in the designated scanning operation period t_{Duty}.

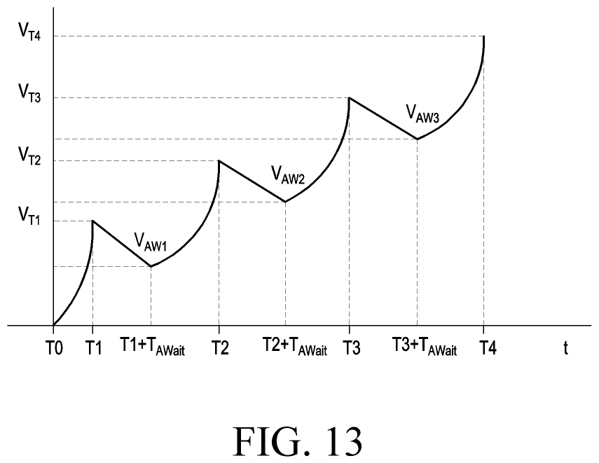

FIG. 13 is a voltage graph of a capacitor charged in a plurality of time intervals according to an embodiment of the disclosure.

A capacitor is charged by connection to a power source (e.g., battery), and the amount of charge or voltage may be calculated by calculus methods. For example, in the case of a circuit in which a battery, resistor, and capacitor are connected, it may be defined by the following Equation 1 according to Ohm's law, voltage law, and the definition of capacitance.

$$\begin{matrix}{V}_{b} = {V}_{R} + {V}_{C} \\ {V}_{b} = IR + \frac{Q}{C} \\ I = \frac{dQ}{dt} and {V}_{b} = R \frac{dQ}{dt} + \frac{Q}{C}\end{matrix} \qquad Equation 1$$

Here, V_{b} is the voltage of the battery, V_{R} is the voltage of the resistor, and V_{C} is the voltage of the capacitor, I is the current, R is the resistance of the resistor, C is the capacitance of the capacitor, and Q is the amount of charge in the capacitor.

The differential Equation 1 has a general solution, and the detailed solution may be calculated by substituting the general solution and boundary conditions. According to the differential Equation 1, the amount of charge in the capacitor may be calculated as the following Equation 2.

$$Q = {CV}_{b} [ 1 - {e}^{- t / RC} ] \qquad Equation 2$$

For example, in the case of a circuit in which a resistor and capacitor are connected, it may be defined by the following Equation 2 according to Ohm's law, voltage law, and the definition of capacitance. According to the following Equation 3, the amount of charge and voltage remaining after discharge over time may be calculated from a state in which the capacitor is charged with an amount of charge of Q₀ and a voltage of V₀ by charging at time t=0.

$$\begin{matrix}{V}_{C} = {V}_{0} {e}^{- t / RC} \\ Q = {CV}_{0} {e}^{- t / RC} \\ I = \frac{{V}_{0}}{R} {e}^{- t / RC}\end{matrix} \qquad Equation 3$$

Referring to FIG. 13, the capacitors (e.g., the capacitors 1030, 1040 of FIG. 10) may be cumulatively charged by the photodiodes (e.g., the photodiodes 1010, 1020 of FIG. 10) during a plurality of time intervals T1, T2, T3, T4. Here, it is assumed that the number of the plurality of time intervals T1, T2, T3, T4 is 4, but it is not limited thereto.

In an embodiment of the disclosure, the capacitors 1030, 1040 may be charged by V_{T1} by the photodiodes 1010, 1020 in the first time interval T1 among the plurality of time intervals T1, T2, T3, T4, since only charging by the photodiodes 1010, 1020 occurred without discharge.

In an embodiment of the disclosure, since the photodiodes 1010, 1020 do not receive light for T_{AWait} time after the first time interval (e.g., first period T1), the capacitors 1030, 1040 may be discharged over time and the voltage may become V_{AW1}.

In an embodiment of the disclosure, the capacitors 1030, 1040 may be charged by the photodiodes 1010, 1020 from the base voltage V_{AW1} to V_{T2} in the second time interval (e.g., second interval T2) among the plurality of time intervals T1, T2, T3, T4. For example, V_{T2} may be the sum of the base voltage V_{AW1} and the voltage charged by the photodiodes 1010, 1020 in the second time interval (e.g., second interval T2). In an embodiment of the disclosure, the capacitors 1030, 1040 may be finally charged to V_{T4} in the last time interval (e.g., fourth interval T4) among the plurality of time intervals T1, T2, T3, T4 in the same manner as described above. For example, the voltage cumulatively charged in each of the plurality of time intervals T1, T2, T3, T4 may be calculated as the following Equation 4.

$$\begin{matrix}{V}_{T 1} = \frac{Q}{{C}_{1}} \times \frac{1}{1 - {e}^{- {t}_{iT} / {R}_{1} {C}_{1}}} \\ {V}_{T 2} = {V}_{AW 1} + \frac{Q}{{C}_{1}} \times \frac{1}{1 - {e}^{- {t}_{iT} / {R}_{1} {C}_{1}}} \\ {V}_{T 3} = {V}_{AW 2} + \frac{Q}{{C}_{1}} \times \frac{1}{1 - {e}^{- {t}_{iT} / {R}_{1} {C}_{1}}} \\ {V}_{T 4} = {V}_{AW 3} + \frac{Q}{{C}_{1}} \times \frac{1}{1 - {e}^{- {t}_{iT} / {R}_{1} {C}_{1}}} \\ {V}_{AW 1} = {V}_{T 1} {e}^{- {t}_{AWait} / {R}_{1} {C}_{1}} \\ {V}_{AW 2} = {V}_{T 2} {e}^{- {t}_{AWait} / {R}_{1} {C}_{1}} \\ {V}_{AW 3} = {V}_{T 3} {e}^{- {t}_{AWait} / {R}_{1} {C}_{1}}\end{matrix} \qquad Equation 4$$

In an embodiment of the disclosure, V_{T4} finally charged during the plurality of time intervals T1, T2, T3, T4 may be larger than V_{T1} charged by the photodiodes 1010, 1020 in each of the plurality of time intervals T1, T2, T3, T4 by the capacitors 1030, 1040.

In an embodiment of the disclosure, the capacitors 1030, 1040 may have a capacitance C1 so that the amount of charge charged in each of the plurality of time intervals T1, T2, T3, T4 is larger than the amount of discharge discharged between the plurality of time intervals T1, T2, T3, T4.

In an embodiment of the disclosure, the voltage charged to the capacitors 1030, 1040 by the photodiodes 1010, 1020 in each of the plurality of time intervals T1, T2, T3, T4 may be larger than the voltage discharged between the plurality of time intervals T1, T2, T3, T4. To meet the condition, the capacitance C1 of the capacitors 1030, 1040 may be derived from the following conditional Equation 5.

$$\begin{matrix}{V}_{T 1} > {V}_{T 1} - {V}_{AW 1} \\ \frac{Q}{C 1} \times \frac{1}{1 - {e}^{- t / τ}} > {V}_{T 1} ( 1 - {e}^{{t}_{AWait} / τ} ) \\ {C}_{1} < \frac{Q}{{V}_{T 1} ( 1 - {e}^{- {t}_{AWait} / τ} )} \\ where , τ = {R}_{1} {C}_{1}\end{matrix} \qquad Equation 5$$

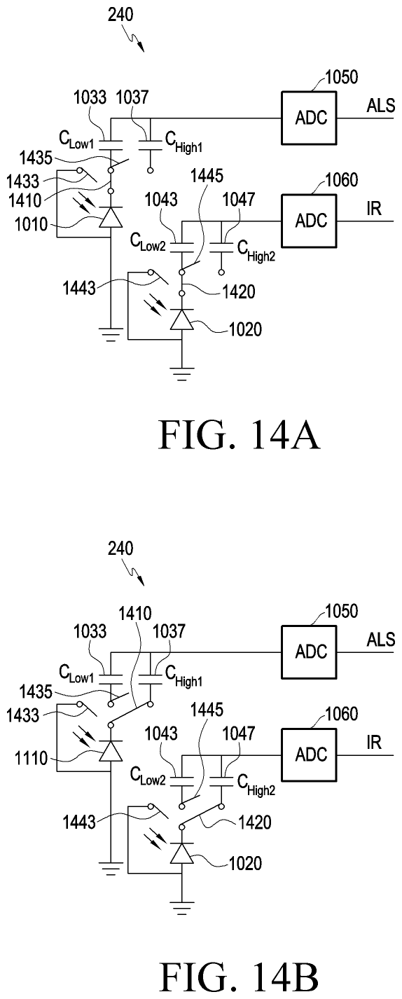

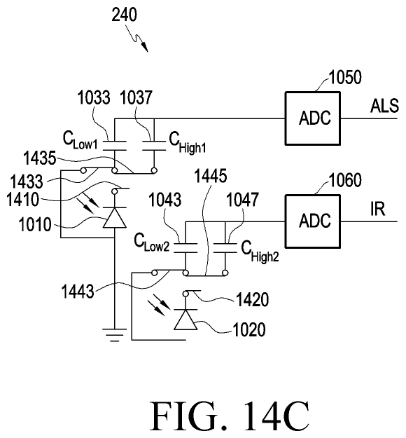

FIGS. 14A, 14B, and 14C illustrate block diagrams of an illuminance sensor 240 in respective operation modes according to various embodiments of the disclosure.

Referring to FIGS. 14A, 14B, and 14C, the illuminance sensor 240 according to an embodiment may include capacitors 1033, 1037, 1043, 1047 electrically connected to the photodiodes 1010, 1020.

The capacitors 1033, 1037, 1043, 1047 according to an embodiment may include first selection capacitors 1033, 1043 and second selection capacitors 1037, 1047 that may be selectively connected to the photodiodes 1010, 1020. In an embodiment of the disclosure, the second selection capacitors 1037, 1047 may have a relatively larger charging capacity than the first selection capacitors 1033, 1043. Here, it has been described that the capacitors 1033, 1037, 1043, 1047 include the first selection capacitors 1033, 1043 and the second selection capacitors 1037, 1047, but three or more capacitors may be included.

In an embodiment of the disclosure, the photodiodes 1010, 1020 and the conversion elements 1050, 1060 may include a first photodiode 1010 and a second photodiode 1020, respectively, and a first conversion element 1050 and a second conversion element 1060, respectively. In an embodiment of the disclosure, the first capacitors 1033, 1037 may be provided with a first selection capacitor 1033 and a second selection capacitor 1037, respectively, corresponding to the first photodiode 1010, and the second capacitors 1043, 1047 may be provided with a first selection capacitor 1043 and a second selection capacitor 1047, respectively, corresponding to the second photodiode 1020.

In an embodiment of the disclosure, since the integration time corresponding to each of the plurality of time intervals T1, T2, T3, T4 is set within the off operation period t_{Doff} of the display 220, the electronic device 101 may change the charging capacity of the capacitors 1033, 1037, 1043, 1047 to correspond to the voltage of the photodiodes 1010, 1020 that varies according to the intensity of ambient light. For example, the electronic device 101 may set the charging capacity of the capacitors 1033, 1037, 1043, 1047 to be relatively small in a low illuminance environment. For example, the electronic device 101 may set the charging capacity of the capacitors 1033, 1037, 1043, 1047 to be relatively large in a high illuminance environment.

The electronic device 101 according to an embodiment may control the illuminance sensor 240 in a plurality of modes (e.g., low illuminance mode, high illuminance mode, and/or reset mode) according to the intensity of ambient light. In an embodiment of the disclosure, the electronic device 101 may change the gain corresponding to the illuminance value measured by the illuminance sensor 240 according to the low illuminance mode or high illuminance mode.

In an embodiment of the disclosure, the electronic device 101 may simultaneously control the first selection capacitor 1033 and second selection capacitor 1037 corresponding to the first photodiode 1010 and the first selection capacitor 1043 and second selection capacitor 1047 corresponding to the second photodiode 1020 in a first mode (e.g., low illuminance mode), a second mode (e.g., high illuminance mode), and/or a third mode (e.g., reset mode). In an embodiment of the disclosure, the electronic device 101 may independently control the first selection capacitor 1033 and second selection capacitor 1037 corresponding to the first photodiode 1010 and the first selection capacitor 1043 and second capacitor 1047 corresponding to the second photodiode 1020 in a first mode (e.g., low illuminance mode), a second mode (e.g., high illuminance mode), and/or a third mode (e.g., reset mode).

In an embodiment of the disclosure, referring to FIG. 14A, the electronic device 101 may control the illuminance sensor 240 in a low illuminance mode when the intensity of ambient light is relatively weak. In an embodiment of the disclosure, the illuminance sensor 240 may electrically connect the photodiodes 1010, 1020 to the first selection capacitors 1033, 1043 in the low illuminance mode. For example, the illuminance sensor 240 may control the first switches 1410, 1420 so that the photodiodes 1010, 1020 and the first selection capacitors 1033, 1043 are connected in the low illuminance mode.

In an embodiment of the disclosure, referring to FIG. 14B, the electronic device 101 may control the illuminance sensor 240 in a high illuminance mode when the intensity of ambient light is relatively strong. In an embodiment of the disclosure, the illuminance sensor 240 may electrically connect the photodiodes 1010, 1020 to the second selection capacitors 1037, 1047 in the high illuminance mode. For example, the illuminance sensor 240 may control the first switches 1410, 1420 so that the photodiodes 1010, 1020 and the second selection capacitors 1037, 1047 are connected in the high illuminance mode.

In an embodiment of the disclosure, referring to FIG. 14C, the electronic device 101 may control the illuminance sensor 240 in the reset mode when the cumulative charging in the plurality of time intervals T1, T2, T3, T4 included in the designated scanning operation period t_{Duty} is completed, or when switching between the low illuminance mode and the high illuminance mode. In an embodiment of the disclosure, the illuminance sensor 240 may connect the first selection capacitors 1033, 1043 and the second selection capacitors 1037, 1047 to ground by bypassing the photodiodes 1010, 1020 in the reset mode. For example, the illuminance sensor may control the second switches 1433, 1443 and the third switches 1435, 1445 so that the first selection capacitors 1033, 1043 and the second selection capacitors 1037, 1047 are connected to ground (GND) by bypassing the photodiodes 1010, 1020 in the reset mode.

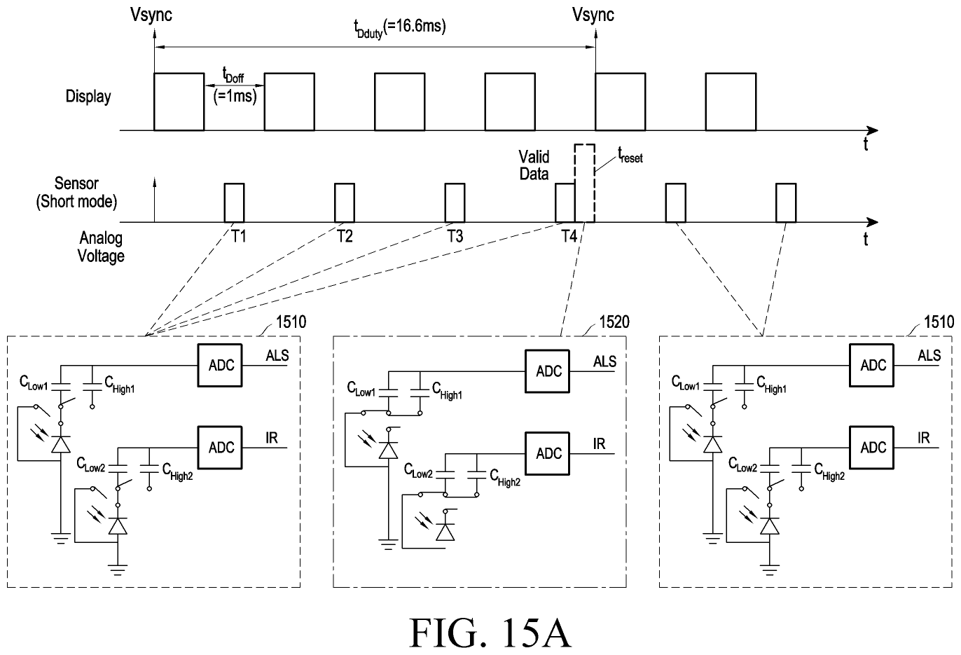

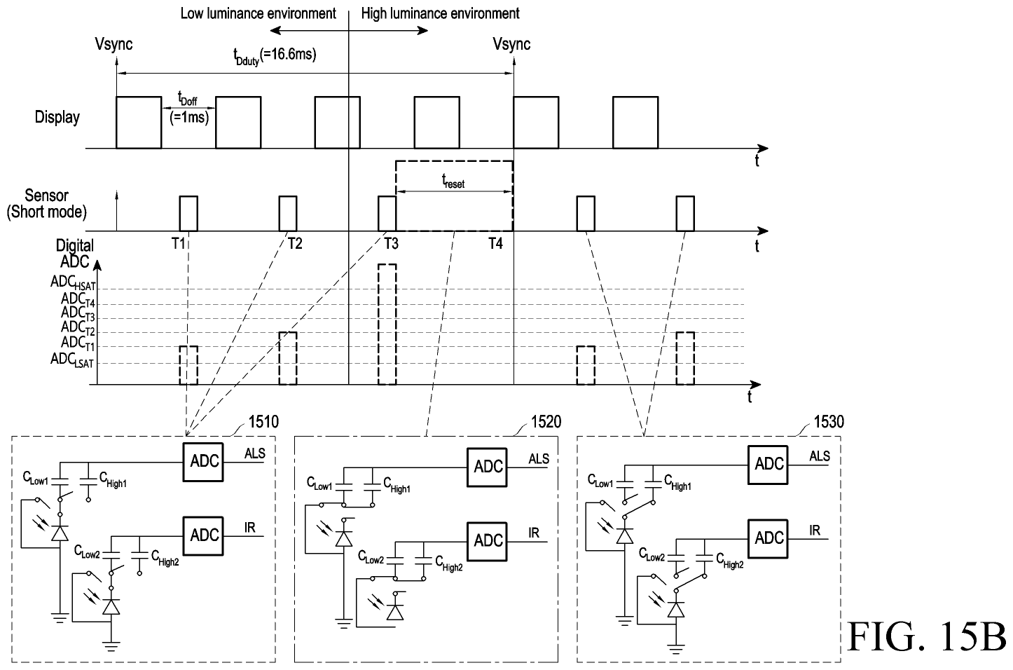

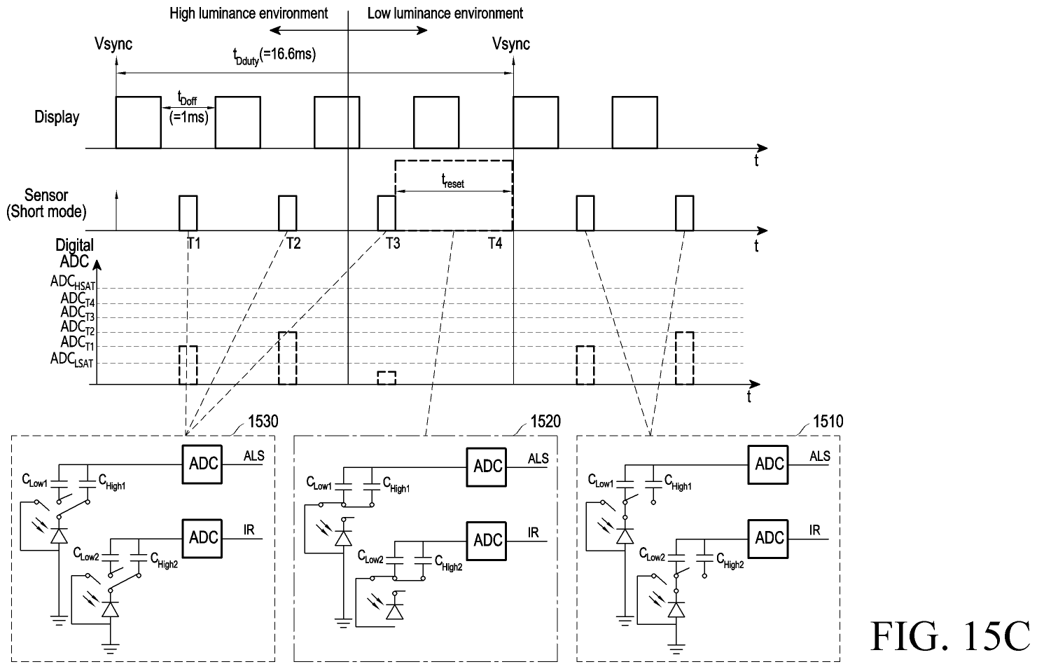

FIG. 15A illustrates operation signals of an illuminance sensor 240 when the same environment is maintained according to an embodiment of the disclosure. FIG. 15B illustrates operation signals of an illuminance sensor 240 when changing from a low illuminance environment to a high illuminance environment according to an embodiment of the disclosure. FIG. 15C illustrates operation signals of an illuminance sensor 240 when changing from a high illuminance environment to a low illuminance environment according to an embodiment of the disclosure.

Referring to FIG. 15A, an electronic device (e.g., the electronic device 101 or processor 210 of FIG. 2) according to an embodiment may receive a signal related to the voltage of capacitors (capacitors 1030, 1040 of FIG. 10) cumulatively charged during a plurality of time intervals T1, T2, T3, T4 included in a designated scanning operation period t_{Duty} by photodiodes (e.g., the photodiodes 1010, 1020 of FIG. 10) when the same environment with little change in ambient illuminance is maintained. In an embodiment of the disclosure, the electronic device 101 may receive a signal related to voltage charged in either the first selection capacitors 1033, 1043 or the second selection capacitors 1037, 1047 electrically connected to the photodiodes 1010, 1020 when the same environment with little change in ambient illuminance is maintained.

The illuminance sensor 240 according to an embodiment may accumulate voltage in either the first selection capacitors 1033, 1043 or the second selection capacitors 1037, 1047 electrically connected to the photodiodes 1010, 1020 during a plurality of time intervals T1, T2, T3, T4 included in a designated scanning operation period t_{Duty} when the same environment with little change in ambient illuminance is maintained.

For example, when the ambient illuminance is relatively low, the illuminance sensor 240 may accumulate voltage in the first selection capacitors 1033, 1043 during a plurality of time intervals T1, T2, T3, T4 while the first selection capacitors 1033, 1043 are electrically connected to the photodiodes 1010, 1020 (e.g., low illuminance mode 1510).

For example, when the ambient illuminance is relatively high, the illuminance sensor 240 may accumulate voltage in the second selection capacitors 1037, 1047 during a plurality of time intervals T1, T2, T3, T4 while the second selection capacitors 1037, 1047 are electrically connected to the photodiodes 1010, 1020 (e.g., high illuminance mode 1530).

In an embodiment of the disclosure, the illuminance sensor 240 may control the reset mode 1520 to discharge either the first selection capacitors 1033, 1043 or the second selection capacitors 1037, 1047 that have been cumulatively charged until Tᵣₑₛₑₜ receiving the next vertical synchronization signal Vsync after accumulating voltage during the plurality of time intervals T1, T2, T3, T4 included in the designated scanning operation period t_{Duty}.

In an embodiment of the disclosure, the electronic device 101 may control the illuminance sensor 240 to the low illuminance mode 1510 or the high illuminance mode 1530 again when receiving a new vertical synchronization signal Vsync.

Referring to FIGS. 15B and 15C, the electronic device 101 according to an embodiment may receive a signal related to voltage charged in either the first selection capacitors 1033, 1043 or the second selection capacitors 1037, 1047 electrically connected to the photodiodes 1010, 1020 while either the first selection capacitors 1033, 1043 or the second selection capacitors 1037, 1047 is electrically connected to the photodiodes 1010, 1020. The electronic device 101 according to an embodiment may control the illuminance sensor 240 to change the capacitor connected to the photodiodes 1010, 1020 based on the signal related to voltage charged in either the first selection capacitors 1033, 1043 or the second selection capacitors 1037, 1047 electrically connected to the photodiodes 1010, 1020.

Referring to FIG. 15B, the electronic device 101 according to an embodiment may control the illuminance sensor 240 so that the second selection capacitors 1037, 1047 are connected to the photodiodes 1010, 1020 when the voltage of the first selection capacitors 1033, 1043 cumulatively charged during the plurality of time intervals T1, T2, T3, T4 while the photodiodes 1010, 1020 are electrically connected to the first selection capacitors 1033, 1043 is equal to or larger than a designated first threshold voltage ADC_{HSAT}.

The electronic device 101 according to an embodiment may enter the low illuminance mode 1510 for the illuminance sensor 240 to select a capacitor corresponding to the ambient environment among the plurality of capacitors 1033, 1037, 1043, 1047. In an embodiment of the disclosure, the electronic device 101 may change to the high illuminance mode 1530 based on the signal related to the voltage charged in the first selection capacitors 1033, 1043 after controlling the illuminance sensor 240 to the low illuminance mode 1510.

The electronic device 101 according to an embodiment may receive the voltage of the first selection capacitors 1033, 1043 cumulatively charged during the plurality of time intervals T1, T2, T3, T4 included in the designated scanning operation period t_{Duty} while the photodiodes 1010, 1020 are electrically connected to the first selection capacitors 1033, 1043 (e.g., low illuminance mode 1510). In an embodiment of the disclosure, the electronic device may identify whether the voltage of the first selection capacitors 1033, 1043 cumulatively charged during the plurality of time intervals T1, T2, T3, T4 included in the received designated scanning operation period t_{Duty} is equal to or larger than a designated first threshold voltage ADC_{HSAT}.

In an embodiment of the disclosure, the electronic device 101 may compare the voltage V_{T1}, V_{T2}, V_{T3} or ADC_{T1}, ADC_{T2}, ADC_{T3} of the first selection capacitors 1033, 1043 cumulatively charged in at least some of the plurality of time intervals T1, T2, T3, T4 included in the designated scanning operation period t_{Duty} with the designated first threshold voltage ADC_{HSAT}.

In an embodiment of the disclosure, the electronic device 101 may compare the final accumulated voltage V_{T4} or ADC_{T4} of the first selection capacitors 1033, 1043 cumulatively charged during the entire plurality of time intervals T1, T2, T3, T4 included in the designated scanning operation period t_{Duty} with the designated first threshold voltage ADC_{HSAT}.

Here, the designated first threshold voltage ADC_{HSAT} may be set based on the charging capacity and/or integration time of the first selection capacitors 1033, 1043. For example, the designated first threshold voltage ADC_{HSAT} may be designated as one value, or may be designated for each of the plurality of time intervals corresponding to the cumulative number of the plurality of time intervals.

In an embodiment of the disclosure, the electronic device 101 may stop the cumulative charging of the first selection capacitors 1033, 1043 in the designated scanning period when the voltage of the first selection capacitors 1033, 1043 cumulatively charged during the plurality of time intervals T1, T2, T3, T4 included in the designated scanning operation period t_{Duty} is equal to or larger than the first threshold voltage ADC_{HSAT}. In an embodiment of the disclosure, the electronic device 101 may control the illuminance sensor 240 to the high illuminance mode 1530 so that the second selection capacitors 1037, 1047 are connected to the photodiodes 1010, 1020 when the voltage of the first selection capacitors 1033, 1043 cumulatively charged during the plurality of time intervals T1, T2, T3, T4 included in the designated scanning operation period t_{Duty} is equal to or larger than the first threshold voltage ADC_{HSAT}.

In an embodiment of the disclosure, the electronic device 101 may control the illuminance sensor 240 to the reset mode 1520 so that the first selection capacitors 1033, 1043 cumulatively charged during the plurality of time intervals are discharged before changing the capacitors 1033, 1037, 1043, 1047 connected to the photodiodes 1010, 1020.

In an embodiment of the disclosure, the electronic device 101 may control the illuminance sensor 240 to the reset mode 1520 for a time tᵣₑₛₑₜ or a designated time between the time when the cumulative charging of the first selection capacitors 1033, 1043 is stopped in the designated scanning period and the time when the next designated scanning operation period t_{Duty} or the next vertical synchronization signal Vsync is received.

In an embodiment of the disclosure, the electronic device 101 may control the illuminance sensor 240 to the high illuminance mode 1530 based on the next designated scanning operation period t_{Duty} or the next vertical synchronization signal Vsync.

Referring to FIG. 15C, the electronic device 101 according to an embodiment may control the illuminance sensor 240 so that the first selection capacitors 1033, 1043 are connected to the photodiodes 1010, 1020 when the voltage of the second selection capacitors 1037, 1047 cumulatively charged during a plurality of time intervals while the photodiodes 1010, 1020 are electrically connected to the second selection capacitors 1037, 1047 (e.g., high illuminance mode 1530) is equal to or less than a designated second threshold voltage.

The electronic device 101 according to an embodiment may receive the voltage of the second selection capacitors 1037, 1047 cumulatively charged during the plurality of time intervals T1, T2, T3, T4 included in the designated scanning operation period t_{Duty} while the photodiodes 1010, 1020 are electrically connected to the second selection capacitors 1037, 1047 (e.g., high illuminance mode 1530). In an embodiment of the disclosure, the electronic device 101 may identify whether the voltage of the second selection capacitors 1037, 1047 cumulatively charged during the plurality of time intervals T1, T2, T3, T4 included in the received designated scanning operation period t_{Duty} is equal to or less than a designated second threshold voltage ADC_{LSAT}.

In an embodiment of the disclosure, the electronic device 101 may compare the voltage V_{T1}, V_{T2}, V_{T3} or ADC_{T1}, ADC_{T2}, ADC_{T3} of the first selection capacitors 1033, 1043 cumulatively charged in at least some of the plurality of time intervals T1, T2, T3, T4 included in the designated scanning operation period t_{Duty} with the designated second threshold voltage ADC_{LSAT}.

In an embodiment of the disclosure, the electronic device 101 may compare the final accumulated voltage V_{T4} or ADC_{T4} of the second selection capacitors 1037, 1047 cumulatively charged during the entire plurality of time intervals T1, T2, T3, T4 included in the designated scanning operation period t_{Duty} with the designated second threshold voltage ADC_{LSAT}.

Here, the designated second threshold voltage ADC_{LSAT} may be set based on the charging capacity and integration time of the second selection capacitors 1037, 1047. For example, the designated second threshold voltage ADC_{LSAT} may be designated as one value, or may be designated for each of the plurality of time intervals corresponding to the cumulative number of the plurality of time intervals.

In an embodiment of the disclosure, the electronic device 101 may stop the cumulative charging of the second selection capacitors 1037, 1047 in the designated scanning period when the voltage of the second selection capacitors 1037, 1047 cumulatively charged during the plurality of time intervals T1, T2, T3, T4 included in the designated scanning operation period t_{Duty} is equal to or less than the second threshold voltage ADC_{LSAT}. In an embodiment of the disclosure, the electronic device 101 may control the illuminance sensor to the low illuminance mode 1510 so that the first selection capacitors 1033, 1043 are connected to the photodiodes 1010, 1020 when the voltage of the second selection capacitors 1037, 1047 cumulatively charged during the plurality of time intervals T1, T2, T3, T4 included in the designated scanning operation period t_{Duty} is equal to or less than the second threshold voltage ADC_{LSAT}.

In an embodiment of the disclosure, the electronic device 101 may control the illuminance sensor to the reset mode 1520 so that the second selection capacitors 1037, 1047 cumulatively charged during the plurality of time intervals are discharged before changing the capacitors 1033, 1037, 1043, 1047 connected to the photodiodes 1010, 1020.

In an embodiment of the disclosure, the electronic device 101 may control the illuminance sensor 240 to the reset mode 1520 for a time tᵣₑₛₑₜ or a designated time between the time when the cumulative charging of the second selection capacitors 1037, 1047 is stopped in the designated scanning period and the time when the next designated scanning operation period t_{Duty} or the next vertical synchronization signal Vsync is received.

In an embodiment of the disclosure, the electronic device 101 may control the illuminance sensor 240 to the low illuminance mode 1510 based on the next designated scanning operation period t_{Duty} or the next vertical synchronization signal Vsync.

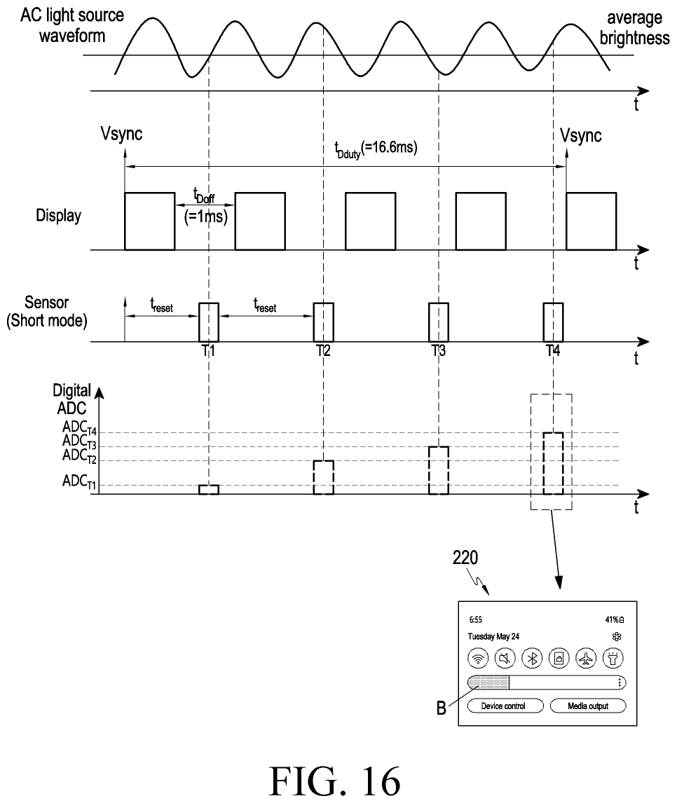

FIG. 16 illustrates operation signals in a short mode of an illuminance sensor 240 when an AC light source is present according to an embodiment of the disclosure.

Referring to FIG. 16, the electronic device 101 according to an embodiment of the disclosure may receive a signal related to the voltage of capacitors 1033, 1037, 1043, 1047 cumulatively charged during the plurality of time intervals T1, T2, T3, T4 from the illuminance sensor 240. The electronic device 101 according to an embodiment may obtain data related to illuminance based on the signal related to the voltage of capacitors 1033, 1037, 1043, 1047 cumulatively charged during the plurality of time intervals T1, T2, T3, T4 from the illuminance sensor 240. In an embodiment of the disclosure, the plurality of time intervals T1, T2, T3, T4 may be set within the off operation period (t_{Doff}, e.g., 1 [ms]) of the display 220. In an embodiment of the disclosure, the electronic device 101 may control the illuminance sensor 240 to the reset mode (e.g., the reset mode 1520 of FIG. 15B) during the time tᵣₑₛₑₜ between the plurality of time intervals T1, T2, T3, T4.

Accordingly, even though the brightness of the AC light source varies over time in the form of a wave, using the voltage of the capacitors 1033, 1037, 1043, 1047 cumulatively charged corresponding to different illuminance in each of the plurality of time intervals T1, T2, T3, T4, the electronic device 101 may measure stable illuminance close to the average brightness of the AC light source.

The electronic device 101 according to an embodiment may adjust the luminance of the screen displayed on the display 220 based on the obtained data related to illuminance. In an embodiment of the disclosure, the electronic device 101 may adjust the designated duty ratio of the display 220, or adjust the intensity of light emitted in the on operation interval of the plurality of pixels (e.g., the plurality of pixels 510 of FIG. 5).

In an embodiment of the disclosure, the electronic device 101 may relatively increase the brightness of the screen displayed on the display 220 when ambient illuminance is relatively high, based on the obtained data related to illuminance. In an embodiment of the disclosure, the electronic device 101 may relatively decrease the brightness of the screen displayed on the display 220 when ambient illuminance is relatively low, based on the obtained data related to illuminance.

Referring to FIG. 16, the electronic device 101 according to an embodiment may maintain constant brightness of the screen displayed on the display 220 by stably measuring illuminance even in an ambient environment including an AC light source. The electronic device 101 according to an embodiment may maintain constant brightness values displayed on a sliding bar B related to brightness of the display 220 illustrated on a screen of the display 220, in preparation for a phenomenon where the sliding bar B of FIG. 9C shakes.

The electronic device 101 according to an embodiment may obtain final data related to illuminance based on both data related to illuminance obtained in short mode of the illuminance sensor 240 and data related to illuminance obtained in long mode of the illuminance sensor 240.

In an embodiment of the disclosure, the electronic device 101 may control the illuminance sensor 240 in long mode and obtain data related to illuminance from the illuminance sensor 240 regardless of optical interference caused by the screen displayed on the display 220.

In an embodiment of the disclosure, the electronic device 101 (e.g., sensor hub 217) may obtain final data related to illuminance based on data related to illuminance obtained in short mode of the illuminance sensor 240 and data related to illuminance obtained in long mode of the illuminance sensor 240 through a comparison algorithm using a color of pixel ratio (COPR) value. In an embodiment of the disclosure, the electronic device 101 may obtain final data related to illuminance using one of data related to illuminance obtained in short mode of the illuminance sensor 240 or data related to illuminance obtained in long mode of the illuminance sensor. In an embodiment of the disclosure, the electronic device 101 may adjust brightness of the screen displayed on the display 220 based on the final data related to illuminance.

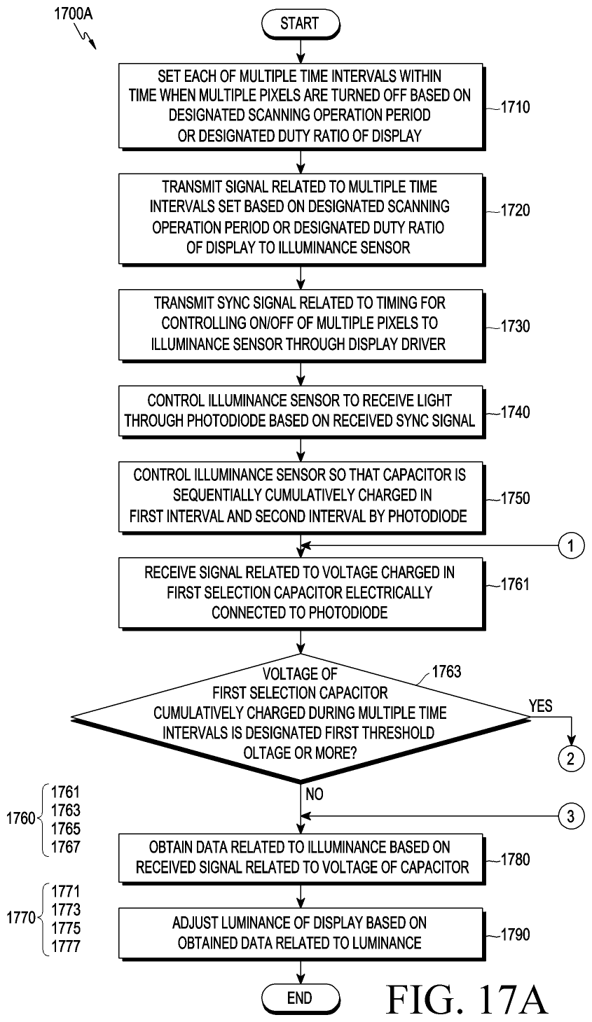

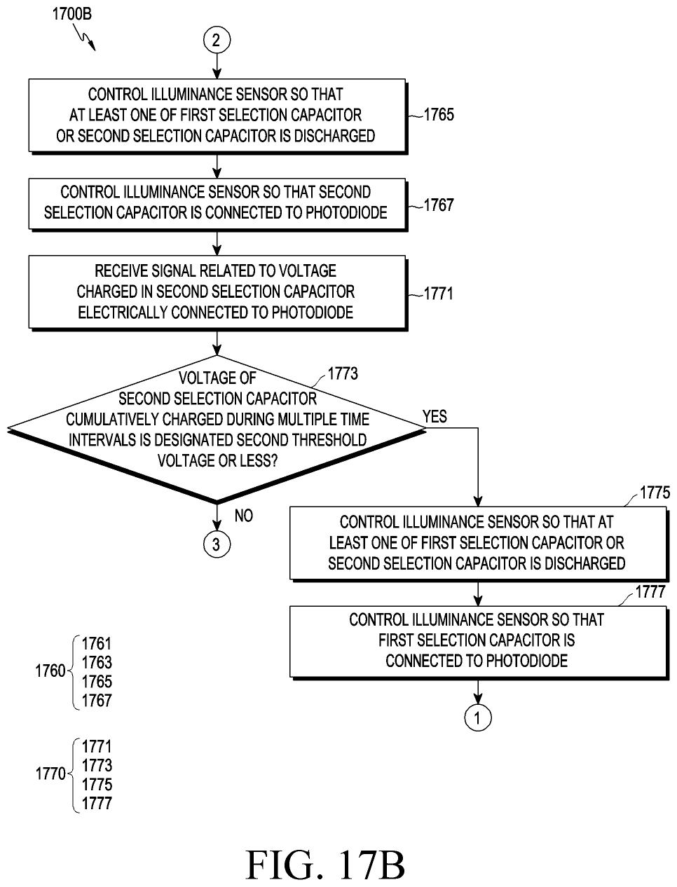

FIGS. 17A and 17B are flowcharts 1700A and 1700B of an operation method of an electronic device 101 according to various embodiments of the disclosure.

Referring to FIGS. 17A and 17B, the electronic device 101 according to an embodiment may, in operation 1710, set a plurality of time intervals within a time t_{Doff} during which a plurality of pixels 510 are turned off, respectively, based on the designated scanning operation period t_{Duty} or the designated duty ratio of the display 220.

The electronic device 101 according to an embodiment may, in operation 1720, transmit a signal related to the plurality of time intervals set based on the designated scanning operation period t_{Duty} or the designated duty ratio of the display 220 to the illuminance sensor 240.

The electronic device 101 according to an embodiment may, in operation 1730, transmit a sync signal related to the timing for controlling on/off of the plurality of pixels 510 to the illuminance sensor 240 through the display driver 230.

The electronic device 101 according to an embodiment may, in operation 1740, control the illuminance sensor 240 to receive light through the photodiodes 360, 1010, 1020 based on the received sync signal.

The electronic device 101 according to an embodiment may, in operation 1750, control the illuminance sensor 240 so that capacitors 1030, 1040, 1033, 1037, 1043, 1047 are sequentially cumulatively charged by the photodiodes 360, 1010, 1020 in a first interval and a second interval.

The electronic device 101 according to an embodiment may, in operations 1760 and 1770, receive a signal related to voltages of the capacitors 1030, 1040, 1033, 1037, 1043, 1047 cumulatively charged during the designated plurality of time intervals by the photodiodes 360, 1010, 1020 from the illuminance sensor 240.

The electronic device 101 according to an embodiment may, in operation 1761, receive a signal related to voltages of first selection capacitors 1033, 1043 cumulatively charged during the designated plurality of time intervals.

The electronic device 101 according to an embodiment may, in operation 1763, identify whether voltages of the first selection capacitors 1033, 1043 cumulatively charged during the plurality of time intervals are equal to or larger than a designated first threshold voltage.

When voltages of the first selection capacitors 1033, 1043 cumulatively charged during the plurality of time intervals are not equal to or larger than the designated first threshold voltage (operation 1763—No), the electronic device 101 according to an embodiment may, in operation 1780, obtain data related to illuminance based on the received signal related to voltages of the first selection capacitors 1033, 1043.

When voltages of the first selection capacitors 1033, 1043 cumulatively charged during the plurality of time intervals are equal to or larger than the designated first threshold voltage (operation 1763—Yes), the electronic device 101 according to an embodiment may, in operation 1765, control the illuminance sensor 240 so that at least one of the first selection capacitors 1033, 1043 or second selection capacitors 1037, 1047 is discharged.

The electronic device 101 according to an embodiment may, in operation 1767, control the illuminance sensor 240 so that the second selection capacitors 1037, 1047 are connected to the photodiodes 360, 1010, 1020.

The electronic device 101 according to an embodiment may, in operation 1771, receive a signal related to voltages of the second selection capacitors 1037, 1047 cumulatively charged during the designated plurality of time intervals.

The electronic device 101 according to an embodiment may, in operation 1773, identify whether voltages of the second selection capacitors 1037, 1047 cumulatively charged during the plurality of time intervals are equal to or less than a designated second threshold voltage.

When voltages of the second selection capacitors 1037, 1047 cumulatively charged during the plurality of time intervals are not equal to or less than the designated second threshold voltage (operation 1773—No), the electronic device 101 according to an embodiment may, in operation 1780, obtain data related to illuminance based on the received signal related to voltages of the second selection capacitors 1037, 1047.

When voltages of the second selection capacitors 1037, 1047 cumulatively charged during the plurality of time intervals are equal to or less than the designated second threshold voltage (operation 1773—Yes), the electronic device 101 according to an embodiment may, in operation 1775, control the illuminance sensor 240 so that at least one of the first selection capacitors 1033, 1043 or the second selection capacitors 1037, 1047 is discharged.

The electronic device 101 according to an embodiment may, in operation 1777, control the illuminance sensor 240 so that the first selection capacitors 1033, 1043 are connected to the photodiodes 360, 1010, 1020. The electronic device 101 according to an embodiment may, in a state in which the illuminance sensor 240 is controlled so that the first selection capacitors 1033, 1043 are connected to the photodiodes 360, 1010, 1020 (after operation 1777), receive a signal related to voltages of the first selection capacitors 1033, 1043 cumulatively charged during the designated plurality of time intervals in operation 1761.

The electronic device 101 according to an embodiment may, in operation 1780, obtain data related to illuminance based on the received signal related to voltages of the capacitors 1030, 1040, 1033, 1037, 1043, 1047.

The electronic device 101 according to an embodiment may, in operation 1790, adjust brightness of the display 220 based on the obtained data related to illuminance.

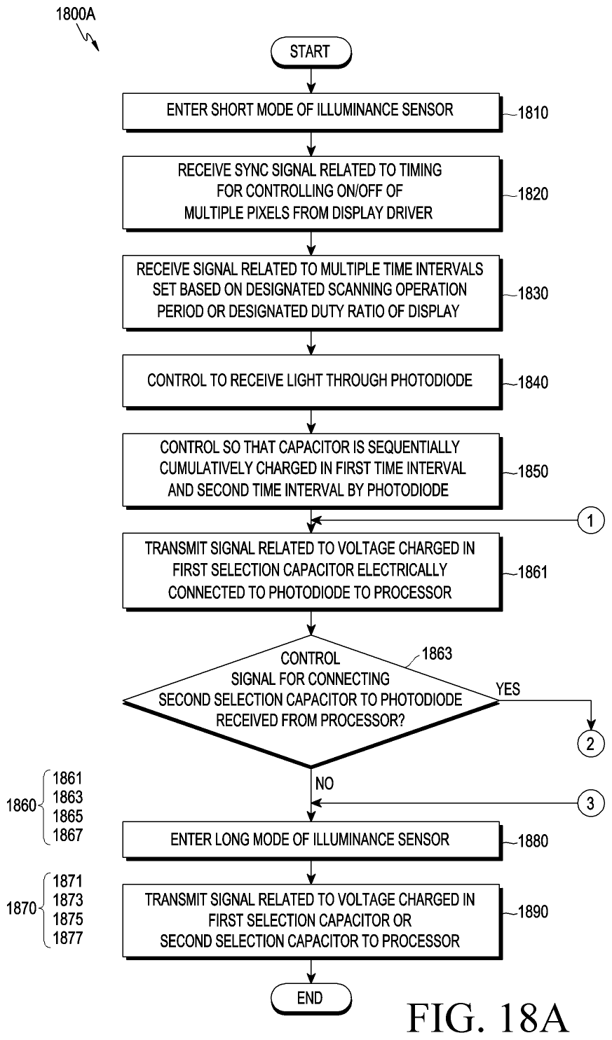

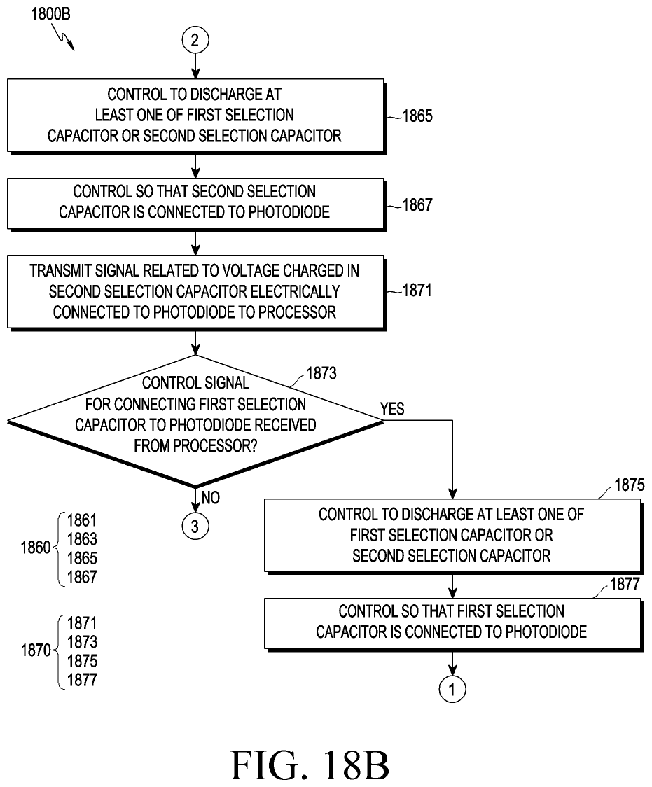

FIGS. 18A and 18B are flowcharts 1800A and 1800B of an operation method of an illuminance sensor 240 according to various embodiments of the disclosure.

Referring to FIGS. 18A and 18B, the illuminance sensor 240 according to an embodiment may enter a short mode in operation 1810. The illuminance sensor 240 according to an embodiment may measure ambient illuminance by receiving ambient light during a relatively short time interval while avoiding optical interference from the display 220 in the short mode.

The illuminance sensor 240 according to an embodiment may, in operation 1820, receive a sync signal related to the timing for controlling on/off of the plurality of pixels 510 from the display driver 230.

The illuminance sensor 240 according to an embodiment may, in operation 1830, receive a signal related to the plurality of time intervals set based on the designated scanning operation period t_{Duty} or the designated duty ratio of the display 220 (e.g., the integration time t_{π} of the plurality of time intervals T1, T2, T3, T4, the period t_{AWait} between the plurality of time intervals T1, T2, T3, T4, and/or the time t_{VALS} between the vertical synchronization signal Vsync and the first time interval T1).

The illuminance sensor 240 according to an embodiment may, in operation 1840, control to receive light through the photodiodes 360, 1010, 1020. In an embodiment of the disclosure, the illuminance sensor 240 may receive light through the plurality of photodiodes 360, 1010, 1020 during the plurality of time intervals set based on the designated scanning operation period t_{Duty} or the designated duty ratio of the display 220.

The illuminance sensor 240 according to an embodiment may, in operation 1850, control so that the capacitors 1030, 1040, 1033, 1037, 1043, 1047 are sequentially cumulatively charged by the photodiodes 360, 1010, 1020 in a first interval and a second interval.

The illuminance sensor 240 according to an embodiment may, in operations 1860 and 1870, transmit a signal related to voltages charged in the capacitors 1030, 1040, 1033, 1037, 1043, 1047 electrically connected to the photodiodes 360, 1010, 1020 to the processor 210, 120.

The illuminance sensor 240 according to an embodiment may, in operation 1861, transmit a signal related to voltages charged in the first selection capacitors 1033, 1043 electrically connected to the photodiodes 360, 1010, 1020 to the processor 210, 120.

The illuminance sensor 240 according to an embodiment may, in operation 1863, identify whether a control signal for connecting the second selection capacitors 1037, 1047 to the photodiodes 360, 1010, 1020 has been received from the processor 210, 120.

When the control signal for connecting the second selection capacitors 1037, 1047 to the photodiodes 360, 1010, 1020 is not received (operation 1863—No), the illuminance sensor 240 according to an embodiment may enter a long mode in operation 1880.

When the control signal for connecting the second selection capacitors 1037, 1047 to the photodiodes 360, 1010, 1020 is received (operation 1863—Yes), the illuminance sensor 240 according to an embodiment may, in operation 1865, control to discharge at least one of the first selection capacitors 1033, 1043 or the second selection capacitors 1037, 1047.

The illuminance sensor 240 according to an embodiment may, in operation 1867, control so that the second selection capacitors 1037, 1047 are connected to the photodiodes 360, 1010, 1020.

The illuminance sensor 240 according to an embodiment may, in operation 1871, transmit a signal related to voltages charged in the second selection capacitors 1037, 1047 electrically connected to the photodiodes 360, 1010, 1020 to the processor 210, 120.

The illuminance sensor 240 according to an embodiment may, in operation 1873, identify whether a control signal for connecting the first selection capacitors 1033, 1043 to the photodiodes 360, 1010, 1020 is received from the processor 210, 120.

When the control signal for connecting the first selection capacitors 1033, 1043 to the photodiodes 360, 1010, 1020 is not received (operation 1873—No), the illuminance sensor 240 according to an embodiment may enter a long mode in operation 1880.

When the control signal for connecting the first selection capacitors 1033, 1043 to the photodiodes 360, 1010, 1020 is received (operation 1873—Yes), the illuminance sensor 240 according to an embodiment may, in operation 1875, control to discharge at least one of the first selection capacitors 1033, 1043 or the second selection capacitors 1037, 1047.

The illuminance sensor 240 according to an embodiment may, in operation 1877, control so that the first selection capacitors 1033, 1043 are connected to the photodiodes 360, 1010, 1020. The illuminance sensor 240 according to an embodiment may, in a state in which the first selection capacitors 1033, 1043 are controlled to be connected to the photodiodes 360, 1010, 1020 (after operation 1877), transmit a signal related to voltages charged in the first selection capacitors 1033, 1043 electrically connected to the photodiodes 360, 1010, 1020 to the processor 210, 120 in operation 1861.

The illuminance sensor 240 according to an embodiment may, in operation 1890, transmit a signal related to voltages charged in the first selection capacitors 1033, 1043 or the second selection capacitors 1037, 1047 to the processor 210, 120 in a state of being controlled in long mode.

Technical objects to be achieved herein are not limited to the foregoing technical objects, and other technical objects not mentioned may be clearly understood by those skilled in the art from the following description.

Effects obtainable from the disclosure are not limited to the above-mentioned effects, and other effects not mentioned may be clearly understood by those skilled in the art from the following description.

An electronic device 101 according to an embodiment of the disclosure may comprise a display 220 displaying a screen visually exposed to a front side through at least a partial area of a panel including a plurality of pixels 510, a display driver 230 configured to control an on/off operation of the plurality of pixels 510 of the display 220 based on a designated scanning operation period t_{Duty} or a designated duty ratio, an illuminance sensor 240 including a photodiode 360, 1010, 1020 positioned at a rear or side of the display 220, a capacitor 1030, 1040, 1033, 1037, 1043, 1047 electrically connected to the photodiode 360, 1010, 1020, and a conversion element 1050, 1060 configured to obtain a signal related to a voltage of the capacitor 1030, 1040, 1033, 1037, 1043, 1047, memory 130 storing instructions, and at least one processor 210, 120. The instructions may, when executed by the at least one processor 210, 120, cause the electronic device 101 to transmit, to the illuminance sensor 240, a signal related to a plurality of time intervals set based on the designated scanning operation period t_{Duty} or the designated duty ratio. The instructions may, when executed by the at least one processor 210, 120, cause the electronic device 101 to identify the signal related to the voltage of the capacitor 1030, 1040, 1033, 1037, 1043, 1047 received from the illuminance sensor 240, the capacitor being cumulatively charged by the photodiode 360, 1010, 1020 during the set plurality of time intervals. The instructions may, when executed by the at least one processor 210, 120, cause the electronic device 101 to obtain data related to illuminance based on the identified signal related to the voltage of the capacitor 1030, 1040, 1033, 1037, 1043, 1047.

In the electronic device 101 according to an embodiment of the disclosure, the plurality of time intervals may include a plurality of temporally separated time intervals. The instructions may cause the electronic device 101 to set each of the plurality of time intervals within a time during which the plurality of pixels 510 are turned off, based on the designated scanning operation period t_{Duty} or the designated duty ratio.

In the electronic device 101 according to an embodiment of the disclosure, the display driver 230 may be configured to transmit, to the illuminance sensor 240, a sync signal related to a timing for controlling on/off operation of the plurality of pixels 510. The illuminance sensor 240 may be configured to receive light through the photodiode 360, 1010, 1020 based on the received sync signal.

In the electronic device 101 according to an embodiment of the disclosure, the plurality of time intervals may be set to have a number of intervals equal to or less than a number of on/off repetitions of the plurality of pixels 510 in the designated scanning operation period t_{Duty}. The instructions may cause the electronic device 101 to, as at least part of obtaining the data related to illuminance, obtain the data related to illuminance based on a signal related to a voltage of the capacitor 1030, 1040, 1033, 1037, 1043, 1047 cumulatively charged during a time of the set number of intervals.

In the electronic device 101 according to an embodiment of the disclosure, the plurality of time intervals may include a first interval and a second interval that is subsequent to the first interval. The instructions may cause the electronic device 101 to control the illuminance sensor 240 so that the capacitor 1030, 1040, 1033, 1037, 1043, 1047 is sequentially and cumulatively charged by the photodiode 360, 1010, 1020 in the first interval and the second interval.

In the electronic device 101 according to an embodiment of the disclosure, the capacitor 1030, 1040, 1033, 1037, 1043, 1047 may have a capacitance so that a charge amount charged in each of the first interval or the second interval is larger than a discharge amount discharged between the first interval and the second interval.

In the electronic device 101 according to an embodiment of the disclosure, the capacitor 1030, 1040, 1033, 1037, 1043, 1047 may include a first selection capacitor 1033, 1043 and a second selection capacitor 1037, 1047 selectively connectable to the photodiode 360, 1010, 1020, the second selection capacitor 1037, 1047 having a relatively larger charging capacity than the first selection capacitor 1033, 1043. The instructions may cause the electronic device 101 to, as at least part of identifying the signal related to the voltage of the capacitor 1030, 1040, 1033, 1037, 1043, 1047, identify a signal related to a voltage charged in any one of the first selection capacitor 1033, 1043 or the second selection capacitor 1037, 1047 electrically connected to the photodiode 360, 1010, 1020. The instructions may cause the electronic device 101 to control the illuminance sensor 240 so that the capacitor 1030, 1040, 1033, 1037, 1043, 1047 connected to the photodiode 360, 1010, 1020 is changed, based on the identified signal related to the voltage charged in the any one of the first selection capacitor 1033, 1043 or the second selection capacitor 1037, 1047.

In the electronic device 101 according to an embodiment of the disclosure, the instructions may cause the electronic device 101 to, as at least part of controlling the illuminance sensor 240 so that the capacitor 1030, 1040, 1033, 1037, 1043, 1047 connected to the photodiode 360, 1010, 1020 is changed, control the illuminance sensor 240 so that the second selection capacitor 1037, 1047 is connected to the photodiode 360, 1010, 1020 when the voltage of the first selection capacitor 1033, 1043 cumulatively charged during the plurality of time intervals while the photodiode 360, 1010, 1020 is electrically connected to the first selection capacitor 1033, 1043 is equal to or larger than a designated first threshold voltage.

In the electronic device 101 according to an embodiment of the disclosure, the instructions may cause the electronic device 101 to as at least part of controlling the illuminance sensor 240 so that the capacitor 1030, 1040, 1033, 1037, 1043, 1047 connected to the photodiode 360, 1010, 1020 is changed, control the illuminance sensor 240 so that the first selection capacitor 1033, 1043 is connected to the photodiode 360, 1010, 1020 when the voltage of the second selection capacitor 1037, 1047 cumulatively charged during the plurality of time intervals while the photodiode 360, 1010, 1020 is electrically connected to the second selection capacitor 1037, 1047 is equal to or less than a designated second threshold voltage.

In the electronic device 101 according to an embodiment of the disclosure, the instructions may cause the electronic device 101 to as at least part of controlling the illuminance sensor 240 so that the capacitor 1030, 1040, 1033, 1037, 1043, 1047 connected to the photodiode 360, 1010, 1020 is changed, control the illuminance sensor 240 so that at least one of the first selection capacitor 1033, 1043 or the second selection capacitor 1037, 1047 cumulatively charged during the plurality of time intervals is discharged before changing the capacitor 1030, 1040, 1033, 1037, 1043, 1047 connected to the photodiode 360, 1010, 1020.

In the electronic device 101 according to an embodiment of the disclosure, the instructions may cause the electronic device 101 to adjust a luminance of the screen displayed on the display 220 based on the obtained data related to illuminance.

A method for operating an electronic device 101 according to an embodiment of the disclosure may comprise transmitting, to an illuminance sensor 240, a signal related to a plurality of time intervals set based on a designated scanning operation period t_{Duty} or a designated duty ratio of a display 220. The display 220 may include a plurality of pixels 510. The method for operating the electronic device 101 according to an embodiment may comprise identifying a signal related to a voltage of a capacitor 1030, 1040, 1033, 1037, 1043, 1047 received from the illuminance sensor 240, the capacitor being cumulatively charged by a photodiode 360, 1010, 1020 during the designated plurality of time intervals. The capacitor 1030, 1040, 1033, 1037, 1043, 1047 may be electrically connected to the photodiode 360, 1010, 1020. The method for operating the electronic device 101 according to an embodiment may comprise obtaining data related to illuminance based on the identified signal related to the voltage of the capacitor 1030, 1040, 1033, 1037, 1043, 1047.

In the method for operating the electronic device 101 according to an embodiment of the disclosure, the plurality of time intervals may include a plurality of temporally separated time intervals. The method for operating the electronic device 101 according to an embodiment may comprise setting each of the plurality of time intervals within a time during which the plurality of pixels 510 are turned off, based on the designated scanning operation period t_{Duty} or the designated duty ratio.

The method for operating the electronic device 101 according to an embodiment may comprise transmitting, to the illuminance sensor 240, a sync signal related to a timing for controlling an on/off operation of the plurality of pixels 510 through a display driver 230 configured to control the on/off operation of the plurality of pixels 510 based on the designated scanning operation period t_{Duty} or the designated duty ratio. The method for operating the electronic device 101 according to an embodiment may comprise controlling the illuminance sensor 240 to receive light through the photodiode 360, 1010, 1020 based on the received sync signal.

In the method for operating the electronic device 101 according to an embodiment of the disclosure, the plurality of time intervals may be set to have a number of intervals equal to or less than a number of on/off repetitions of the plurality of pixels 510 in the designated scanning operation period t_{Duty}. In the method for operating the electronic device 101 according to an embodiment of the disclosure, obtaining the data related to illuminance may obtain the data related to illuminance based on a signal related to a voltage of the capacitor 1030, 1040, 1033, 1037, 1043, 1047 cumulatively charged during a time of the set number of intervals.

In the method for operating the electronic device 101 according to an embodiment of the disclosure, the plurality of time intervals may include a first interval and a second interval that is subsequent to the first interval. The method for operating the electronic device 101 according to an embodiment of the disclosure may further comprise controlling the illuminance sensor 240 so that the capacitor 1030, 1040, 1033, 1037, 1043, 1047 is sequentially and cumulatively charged by the photodiode 360, 1010, 1020 in the first interval and the second interval.

In the method for operating the electronic device 101 according to an embodiment of the disclosure, the capacitor 1030, 1040, 1033, 1037, 1043, 1047 may include a first selection capacitor 1033, 1043 and a second selection capacitor 1037, 1047 selectively connectable to the photodiode 360, 1010, 1020, the second selection capacitor 1037, 1047 having a relatively larger charging capacity than the first selection capacitor 1033, 1043. In the method for operating the electronic device 101 according to an embodiment of the disclosure, identifying the signal related to the voltage of the capacitor 1030, 1040, 1033, 1037, 1043, 1047 may include identifying a signal related to a voltage charged in any one of the first selection capacitor 1033, 1043 or the second selection capacitor 1037, 1047 electrically connected to the photodiode 360, 1010, 1020, and controlling the illuminance sensor 240 so that the capacitor 1030, 1040, 1033, 1037, 1043, 1047 connected to the photodiode 360, 1010, 1020 is changed, based on the identified signal related to the voltage charged in the any one of the first selection capacitor 1033, 1043 or the second selection capacitor 1037, 1047.

In the method for operating the electronic device 101 according to an embodiment of the disclosure, controlling the illuminance sensor 240 so that the capacitor 1030, 1040, 1033, 1037, 1043, 1047 connected to the photodiode 360, 1010, 1020 is changed may include controlling the illuminance sensor 240 so that the second selection capacitor 1037, 1047 is connected to the photodiode 360, 1010, 1020 when the voltage of the first selection capacitor 1033, 1043 cumulatively charged during the plurality of time intervals while the photodiode 360, 1010, 1020 is electrically connected to the first selection capacitor 1033, 1043 is equal to or larger than a designated first threshold voltage.

In the method for operating the electronic device 101 according to an embodiment of the disclosure, controlling the illuminance sensor 240 so that the capacitor 1030, 1040, 1033, 1037, 1043, 1047 connected to the photodiode 360, 1010, 1020 is changed may control the illuminance sensor 240 so that the first selection capacitor 1033, 1043 is connected to the photodiode 360, 1010, 1020 when the voltage of the second selection capacitor 1037, 1047 cumulatively charged during the plurality of time intervals while the photodiode 360, 1010, 1020 is electrically connected to the second selection capacitor 1037, 1047 is equal to or less than a designated second threshold voltage.

In the method for operating the electronic device 101 according to an embodiment of the disclosure, controlling the illuminance sensor 240 so that the capacitor 1030, 1040, 1033, 1037, 1043, 1047 connected to the photodiode 360, 1010, 1020 is changed may include controlling the illuminance sensor 240 so that at least one of the first selection capacitor 1033, 1043 or the second selection capacitor 1037, 1047 cumulatively charged during the plurality of time intervals is discharged before changing the capacitor 1030, 1040, 1033, 1037, 1043, 1047 connected to the photodiode 360, 1010, 1020.

In a storage medium storing computer-readable instructions according to an embodiment of the disclosure, the instructions may, when executed by at least one processor 210, 120 of an electronic device 101, cause the electronic device 101 to transmit, to an illuminance sensor 240, a signal related to a plurality of time intervals set based on a designated scanning operation period or a designated duty ratio of a display 220. The display 220 may include a plurality of pixels 510. The instructions may, when executed by at least one processor 210, 120 of the electronic device 101, cause the electronic device 101 to identify a signal related to a voltage of a capacitor 1030, 1040, 1033, 1037, 1043, 1047 received from the illuminance sensor 240, the capacitor being cumulatively charged by a photodiode 360, 1010, 1020 during the designated plurality of time intervals. The capacitor 1030, 1040, 1033, 1037, 1043, 1047 may be electrically connected to the photodiode 360; 1010, 1020. The instructions may, when executed by the at least one processor 210, 120 of the electronic device 101, cause the electronic device 101 to obtain data related to illuminance based on the identified signal related to the voltage of the capacitor 1030, 1040, 1033, 1037, 1043, 1047.

The electronic device according to an embodiment may be one of various types of electronic devices. The electronic devices may include, for example, a portable communication device (e.g., a smart phone), a computer device, a portable multimedia device, a portable medical device, a camera, an electronic device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment of the disclosure, each component (e.g., a module or a program) of the above-described components may include a single entity or multiple entities. Some of the plurality of entities may be separately disposed in different components. According to an embodiment of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display configured to present a screen visually exposed to a front side through at least a partial area of a panel including a plurality of pixels;
a display driver configured to control on/off operations of the plurality of pixels of the display based on a designated scanning operation period or a designated duty ratio;
an illuminance sensor including:
a photodiode disposed at a rear or side of the display,
a capacitor electrically connected to the photodiode, and
a conversion element configured to obtain a signal related to a voltage of the capacitor;
memory, comprising one or more storage media, storing instructions; and
at least one processor communicatively coupled to the display, the display driver, the illuminance sensor, and the memory,
wherein the instructions, when executed by the at least one processor individually or collectively, cause the electronic device to:
transmit, to the illuminance sensor, a signal related to a plurality of time intervals set based on the designated scanning operation period and/or the designated duty ratio,
identify the signal related to the voltage of the capacitor received from the illuminance sensor, the capacitor being cumulatively charged by the photodiode during the plurality of time intervals, and
obtain data related to illuminance based on the identified signal related to the voltage of the capacitor.

2. The electronic device of claim 1,
wherein the plurality of time intervals includes a plurality of temporally separated time intervals, and
wherein the instructions, when executed by the at least one processor individually or collectively, further cause the electronic device to set each of the plurality of time intervals within a period during which the plurality of pixels are turned off, based on the designated scanning operation period or the designated duty ratio.

3. The electronic device of claim 2,
wherein the display driver is configured to transmit, to the illuminance sensor, a sync signal related to a timing for controlling on/off operations of the plurality of pixels, and
wherein the illuminance sensor is configured to receive light through the photodiode based on the sync signal.

4. The electronic device of claim 1,
wherein the plurality of time intervals is set to have a number of intervals equal to or less than a number of on/off repetitions of the plurality of pixels within the designated scanning operation period, and
wherein the instructions, when executed by the at least one processor individually or collectively, further cause the electronic device to obtain the data related to illuminance based on a signal related to a voltage of the capacitor cumulatively charged during a time of the set number of intervals.

5. The electronic device of claim 1,
wherein the plurality of time intervals includes a first interval and a second interval subsequent to the first interval, and
wherein the instructions, when executed by the at least one processor individually or collectively, further cause the electronic device to control the illuminance sensor to enable the capacitor being sequentially and cumulatively charged by the photodiode during the first interval and the second interval.

6. The electronic device of claim 5, wherein the capacitor has a capacitance in which a charge amount charged in each of the first interval or the second interval is larger than a discharge amount discharged between the first interval and the second interval.

7. The electronic device of claim 1,
wherein the capacitor includes a first selection capacitor and a second selection capacitor selectively connectable to the photodiode, the second selection capacitor having a relatively larger charging capacity than the first selection capacitor, and
wherein the instructions, when executed by the at least one processor individually or collectively, further cause the electronic device to:
identify a signal related to a voltage charged in any one of the first selection capacitor or the second selection capacitor electrically connected to the photodiode, and
control the illuminance sensor to switch the capacitor connected to the photodiode, based on the identified signal related to the voltage charged in the any one of the first selection capacitor or the second selection capacitor.

8. The electronic device of claim 7, wherein the instructions, when executed by the at least one processor individually or collectively, further cause the electronic device to control the illuminance sensor to connect the second selection capacitor to the photodiode when the voltage of the first selection capacitor cumulatively charged during the plurality of time intervals while the photodiode is electrically connected to the first selection capacitor is equal to or larger than a designated first threshold voltage.

9. The electronic device of claim 7, wherein the instructions, when executed by the at least one processor individually or collectively, further cause the electronic device to control the illuminance sensor to connect the first selection capacitor to the photodiode when the voltage of the second selection capacitor cumulatively charged during the plurality of time intervals while the photodiode is electrically connected to the second selection capacitor is equal to or less than a designated second threshold voltage.

10. The electronic device of claim 7, wherein the instructions, when executed by the at least one processor individually or collectively, further cause the electronic device to control the illuminance sensor to discharge at least one of the first selection capacitor or the second selection capacitor, cumulatively charged during the plurality of time intervals, before changing the capacitor connected to the photodiode.

11. The electronic device of claim 1, wherein the instructions, when executed by the at least one processor individually or collectively, further cause the electronic device to adjust a luminance of the screen presented on the display based on the obtained data related to illuminance.

12. A method for operating an electronic device, the method comprising:
transmitting, to an illuminance sensor, a signal related to a plurality of time intervals set based on a designated scanning operation period and/or a designated duty ratio of a display, the display including a plurality of pixels;
identifying a signal related to a voltage of a capacitor received from the illuminance sensor, the capacitor being cumulatively charged by a photodiode during the plurality of time intervals, the capacitor being electrically connected to the photodiode; and
obtaining data related to illuminance based on the identified signal related to the voltage of the capacitor.

13. The method of claim 12,
wherein the plurality of time intervals includes a plurality of temporally separated time intervals, and
wherein the method further comprises setting each of the plurality of time intervals within a period during which the plurality of pixels are turned off, based on the designated scanning operation period or the designated duty ratio.

14. The method of claim 13, further comprising:
transmitting, to the illuminance sensor, a sync signal related to a timing for controlling on/off operations of the plurality of pixels through a display driver configured to control the on/off operation of the plurality of pixels based on the designated scanning operation period or the designated duty ratio; and
controlling the illuminance sensor to receive light through the photodiode based on the sync signal.

15. The method of claim 12,
wherein the plurality of time intervals is set to have a number of intervals equal to or less than a number of on/off repetitions of the plurality of pixels within the designated scanning operation period, and
wherein the method further comprises obtaining the data related to illuminance based on a signal related to a voltage of the capacitor cumulatively charged during a time of the set number of intervals.

16. The method of claim 12,
wherein the plurality of time intervals includes a first interval and a second interval subsequent to the first interval, and
wherein the method further comprises controlling the illuminance sensor to enable the capacitor being sequentially and cumulatively charged by the photodiode during the first interval and the second interval.

17. The method of claim 16, wherein the capacitor has a capacitance in which a charge amount charged in each of the first interval or the second interval is larger than a discharge amount discharged between the first interval and the second interval.

18. The method of claim 12,
wherein the capacitor includes a first selection capacitor and a second selection capacitor selectively connectable to the photodiode, the second selection capacitor having a relatively larger charging capacity than the first selection capacitor, and
wherein the method further comprises:
identifying a signal related to a voltage charged in any one of the first selection capacitor or the second selection capacitor electrically connected to the photodiode, and
controlling the illuminance sensor to switch the capacitor connected to the photodiode, based on the identified signal related to the voltage charged in the any one of the first selection capacitor or the second selection capacitor.

19. One or more non-transitory computer-readable storage media storing one or more computer programs including computer-executable instructions that, when executed by at least one processor of an electronic device individually or collectively, causing the electronic device to perform operations, the operations comprising:
transmitting, to an illuminance sensor, a signal related to a plurality of time intervals set based on a designated scanning operation period and/or a designated duty ratio of a display, the display including a plurality of pixels;
identifying a signal related to a voltage of a capacitor received from the illuminance sensor, the capacitor being cumulatively charged by a photodiode during the plurality of time intervals, the capacitor being electrically connected to the photodiode; and
obtaining data related to illuminance based on the identified signal related to the voltage of the capacitor.

20. The one or more non-transitory computer-readable storage media of claim 19,
wherein the plurality of time intervals includes a plurality of temporally separated time intervals, and
wherein the operations further comprising setting each of the plurality of time intervals within a period during which the plurality of pixels are turned off, based on the designated scanning operation period or the designated duty ratio.
